(19) United States
(12) Patent Application Publication
(10) Pub. No.: US 2012/0123786 A1
(43) Pub. Date: May 17, 2012

(54) Method for identifying and protecting information

(76) Inventors: David Valin, Flushing, NY (US); Alex Socolof, Briarcliff Manor, NY (US)

(21) Appl. No.: 13/332,173

(22) Filed: Dec. 20, 2011

Related U.S. Application Data
(63) Continuation of application No. 12/653,749, filed on Dec. 17, 2009, now abandoned.

(51) Int. Cl. G06K 9/00; G06F 21/00; G06Q 50/22; G10L 11/00; G06Q 40/02; G06Q 30/06

(52) U.S. Cl. 704/273; 705/44; 705/26.1; 705/3; 705/43; 705/41; 382/115; 382/118; 726/26; 704/E17.001

(57) ABSTRACT

A method for identifying and authenticating a user and protecting information. The identification process is enabled by using a mobile device such as a smartphone, laptop, or thin client device. A user speaks a phrase to create an audio voiceprint while a camera streams video images and creates a video print. The video data is converted to a color band calculated pattern to numbers. The audio voiceprint, video print, and color band are registered in a database as a digital fingerprint. Processing of all audio and video input occurs on a human key system server so there is not usage by the thin client systems used by the user to access the human key server for authentication and verification. When a user registers an audio and video fingerprint is created and stored in the database as reference to identify that individual for the purpose of verification.

### CROSS REFERENCE TO RELATED APPLICATIONS

This application claims priority from and is a Continuation of U.S. patent application Ser. No. 12/653,749, entitled “Method and mechanism for identifying protecting, requesting, assisting and managing information”, filed on 17 Dec. 2009, which is incorporated by reference in its entirety for all purposes as if fully set forth herein.

### TECHNICAL FIELD OF THE INVENTION

The present invention generally relates to a method for identifying and protecting information. More specifically the present invention relates a method of identifying and authenticating a user's identity and transmitting protected information to the identified and authenticated user.

### BACKGROUND OF THE INVENTION

The ways in which someone may be authenticated fall into three categories, based on what are known as the factors of authentication: something a user know, something a user have, or something a user are. Each authentication factor covers a range of elements used to authenticate or verify a person's identity prior to being granted access, approving a transaction request, signing a document or other work product, granting authority to others, and establishing a chain of authority.

Security research has determined that for a positive identification, elements from at least two, and preferably all three, factors be verified. The three factors (classes) and some of elements of each factor are: the ownership factors: something the user has (e.g., wrist band, ID card, security token, software token, phone, or cell phone); the knowledge factors: something the user knows (e.g., a password, pass phrase, or personal identification number (PIN), challenge response (the user must answer a question)); and the inherence factors: something the user is or does (e.g., fingerprint, retinal pattern, DNA sequence (there are assorted definitions of what is sufficient), signature, face, voice, unique bio-electric signals, or other biometric identifier).

When elements representing two factors are required for identification, the term two-factor authentication is applied. . e.g. a bankcard (something the user has) and a PIN (something the user knows). Business networks may require users to provide a password (knowledge factor) and a pseudorandom number from a security token (ownership factor). Access to a very high security system might require a mantrap screening of height, weight, facial, and fingerprint checks (several inherence factor elements) plus a PIN and a day code (knowledge factor elements), but this is still a two-factor authentication.

Counterfeit products are often offered to consumers as being authentic. Counterfeit consumer goods such as electronics, music, apparel, and counterfeit medications have been sold as being legitimate. Efforts to control the supply chain and educate consumers to evaluate the packaging and labeling help ensure that authentic products are sold and used. Even security printing on packages, labels, and nameplates, however, is subject to counterfeiting.

One familiar use of authentication and authorization is access control. A computer system that is supposed to be used only by those authorized must attempt to detect and exclude the unauthorized. Access to it is therefore usually controlled by insisting on an authentication procedure to establish with some degree of confidence the identity of the user, granting privileges established for that identity. Common examples of access control involving authentication include: Asking for photoID when a contractor first arrives at a house to perform work; Using captcha as a means of asserting that a user is a human being and not a computer program; A computer program using a blind credential to authenticate to another program; Logging in to a computer; Using a confirmation E-mail to verify ownership of an e-mail address; Using an Internet banking system; and Withdrawing cash from an ATM.

In some cases, ease of access is balanced against the strictness of access checks. For example, the credit card network does not require a personal identification number for authentication of the claimed identity; and a small transaction usually does not even require a signature of the authenticated person for proof of authorization of the transaction. The security of the system is maintained by limiting distribution of credit card numbers, and by the threat of punishment for fraud.

Security experts argue that it is impossible to prove the identity of a computer user with absolute certainty. It is only possible to apply one or more tests which, if passed, have been previously declared to be sufficient to proceed. The problem is to determine which tests are sufficient, and many such are inadequate. Any given test can be spoofed one way or another, with varying degrees of difficulty.

Therefore, what is needed is a method and apparatus for proving identity of a computer or other electronic device user by applying one or more tests which are sufficient to proceed with allowing access and which are adequate in certainty of identity of a user.

### DEFINITIONS

A “human key” is a software identification file that enables a user to verify themselves to another user or a computer system. The software file of the human key enables a user to be verified and/or authenticated in a transaction and also provides tracking of the financial transaction by associating the transaction to one or more human keys which identify and authenticate a user in the system.

A “software application” is a program or group of programs designed for end users. Application software can be divided into two general classes: systems software and applications software. Systems software consists of low-level programs that interact with the computer at a very basic level. This includes operating systems, compilers, and utilities for managing computer resources. In contrast, applications software (also called end-user programs) includes database programs, word processors, and spreadsheets. Figuratively speaking, applications software sits on top of systems software because it is unable to run without the operating system and system utilities.

A “software module” is a file that contains instructions. “Module” implies a single executable file that is only a part of the application, such as a DLL. When referring to an entire program, the terms “application” and “software program” are typically used.

A “software application module” is a program or group of programs designed for end users that contains one or more files that contains instructions to be executed by a computer or other equivalent device.

A “thin client devoice” (sometimes also called a lean or slim client) is a computer or a computer program which depends heavily on some other computer (its server) to fulfill its traditional computational roles. This stands in contrast to the traditional fat client, a computer designed to take on these roles by itself The exact roles assumed by the server may vary, from providing data persistence (for example, for diskless nodes) to actual information processing on the client's behalf.

A “website”, also written as Web site, web site, or simply site, is a collection of related web pages containing images, videos or other digital assets. A website is hosted on at least one web server, accessible via a network such as the Internet or a private local area network through an Internet address known as a Uniform Resource Locator (URL). All publicly accessible websites collectively constitute the World Wide Web.

A “web page”, also written as webpage is a document, typically written in plain text interspersed with formatting instructions of Hypertext Markup Language (HTML, XHTML). A web page may incorporate elements from other websites with suitable markup anchors.

Web pages are accessed and transported with the Hypertext Transfer Protocol (HTTP), which may optionally employ encryption (HTTP Secure, HTTPS) to provide security and privacy for the user of the web page content. The user's application, often a web browser displayed on a computer, renders the page content according to its HTML markup instructions onto a display terminal. The pages of a website can usually be accessed from a simple Uniform Resource Locator (URL) called the homepage. The URLs of the pages organize them into a hierarchy, although hyperlinking between them conveys the reader's perceived site structure and guides the reader's navigation of the site.

A “mobile device” is a generic term used to refer to a variety of devices that allow people to access data and information from where ever they are. This includes cell phones and other portable devices such as, but not limited to, PDAs, Pads, smartphones, and laptop computers.

“Social network sites” are web-based services that allow individuals to (1) construct a public or semi-public profile within a bounded system, (2) articulate a list of other users with whom they share a connection, and (3) view and traverse their list of connections and those made by others within the system. The nature and nomenclature of these connections may vary from site to site. While we use the terms “social network”, “social network pages”, and “social network site” to describe this phenomenon, the term “social networking sites” also appears in public discourse, and the variation of terms are often used interchangeably.

### SUMMARY OF THE INVENTION

The presented invention is a method for identifying and authenticating a user and protecting information. The identification process is enabled by using a mobile device such as a smartphone or a laptop computer, PC, or equivalent thin client device. First a user speaks a phrase to create an audio voiceprint. Next the camera streams video images and creates a video print. The video data is converted to a color band calculated pattern to numbers. The audio voiceprint, video print, color band calculated pattern to numbers are registered in a database with spatial interpolation algorithm as a digital fingerprint. Processing of all audio and video input occurs on a human key system server so there is not usage by the thin client systems used by the user to access the human key server for authentication and verification. When a user/person registers in the system an audio and video fingerprint is created, which comprises audio file, video file, image files, text files, and all other files and data that is stored in the database, that are created as reference to identify the individual for the purpose of verification.

After registration and login, a user can then use the identification and authentication method provided by the present invention for protecting and distributing information. The user can use the method in financial transactions, campaigns, and medical settings as taught in the application, but is not limited in application.

### BRIEF DESCRIPTION OF THE DRAWINGS

The accompanying drawings, which are incorporated in and constitute a part of this specification exemplify the embodiments of the present invention and, together with the description, serve to explain and illustrate principles of the inventive technique. Specifically:

FIG. 1 is a flow chart of the 3D camera method of the present invention;

FIG. 2 is a flow chart illustrating the registration and login process of the present invention;

FIG. 3 is a flow chart illustrating the method applied to a credit card transaction;

FIG. 4 is a flow chart illustrating the Viewing and Recording Mechanism with Color Band Encryption De-Encryption Security;

FIG. 5 is a series of illustrated screen shots of the login process and emergency 911 process;

FIG. 6 is a flow chart illustrating the method applied to a purchase transaction;

FIG. 7 is a flow chart illustrating the recording process of the present invention;

FIGS. 8-13 are flow charts and screen shots illustrating the method applied to a medical journal;

FIG. 14 is a flow chart and screen shot illustrating the tracking and calendar process of the present invention;

FIG. 15 is a flow chart illustrating the method applied to a distribution process;

FIG. 16 is a flow chart illustrating the method applied to a tracking and alert process;

FIG. 17 is a flow chart illustrating the method applied to a campaign process;

FIGS. 18-20 are flow charts illustrating the object identification process of the present invention;

FIGS. 21-23 is a flow chart illustrating the method applied to a financial check transaction; and

FIGS. 24-25 are flow charts illustrating the method applied to a debit card transaction;

FIG. 26 is a schematic of the spatial point delivery method;

FIG. 27 is a flow chart of the spatial point process;

FIGS. 28 is flow chart for the process of spatial point targeting in a moving vehicle;

FIG. 29 is a schematic of spatial point targeting in a moving vehicle; and

FIG. 30 is a flow chart detailing the method of the spatial point targeting process.

### DETAILED DESCRIPTION OF THE INVENTION

In the following detailed description, reference will be made to the accompanying drawings, in which identical functional elements are designated with like numerals. The aforementioned accompanying drawings show by way of illustration and not by way of limitation, specific embodiments and implementations consistent with principles of the present invention. These implementations are described in sufficient detail to enable those skilled in the art to practice the invention and it is to be understood that other implementations may be utilized and that structural changes and substitutions of various elements may be made without departing from the scope and spirit of present invention. The following detailed description is, therefore, not to be construed in a limited sense. Additionally, the various embodiments of the invention as described may be implemented in the form of software running on a general purpose computer, in the form of a specialized hardware, or combination of software and hardware.

The current present invention is an apparatus for identifying protecting, requesting, assisting and managing information. The apparatus is executed on a computer, laptop, mobile computing device, smartphone, or any other machine comprising the hardware components required by the apparatus of the present invention and capable of executing software to control and enable functionality of the hardware components of the apparatus of the present invention.

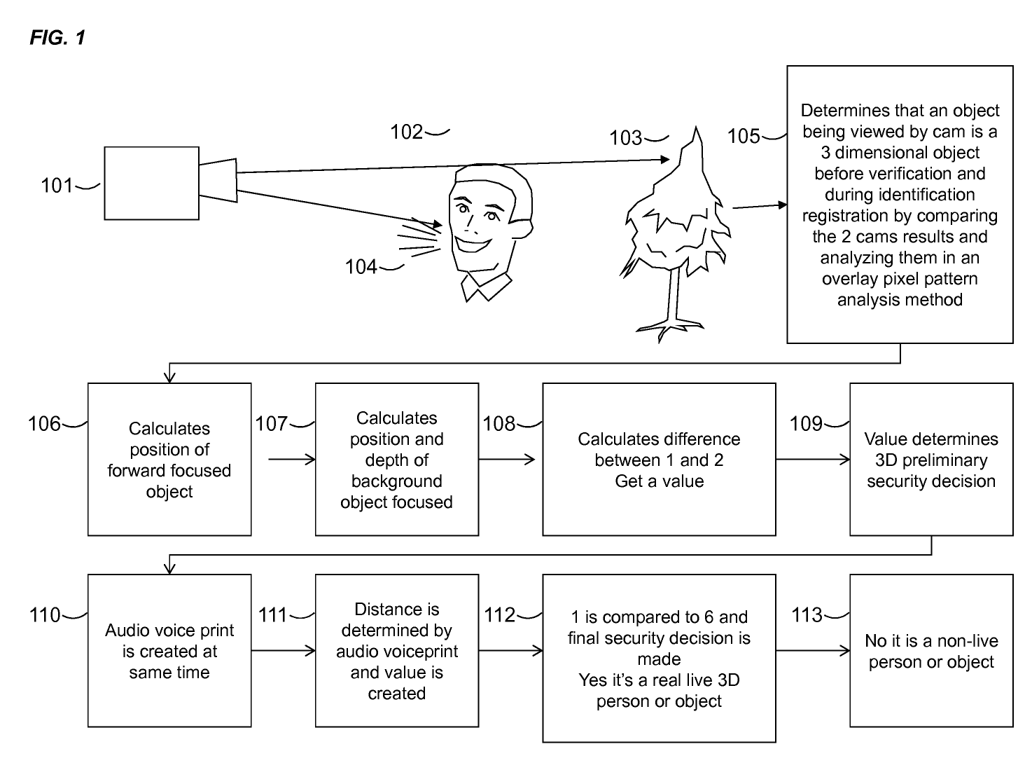

Referring to FIG. 1, a camera method of the present invention is shown. In this embodiment a camera or camera 101 records audio and visual input 104 of a user 102 and records visual background information 103. Next, software running on a machine or computer system enables the method of the present invention to determining that an object being viewed by camera is a three dimensional object before verification and during identification registration by comparing the two cams results and analyzing them in an overlay pixel pattern analysis method 105. In a first step the position of a forward focused object is calculated 106.

Next, the position and depth of background object focused is calculated 107. The difference between the first and second values is determined 108 and that value determines a preliminary 3D security decision 109. An audio voice print is created at the same time as the video calculation 110. Distance is determined by audio voiceprint and a value is determined 111. The calculated position of the forward focused object is compared to the distance determined by the audio voiceprint and a final security decision is made on whether the object is a real live 3D person or object 112 or it is a non-live person or object 113.

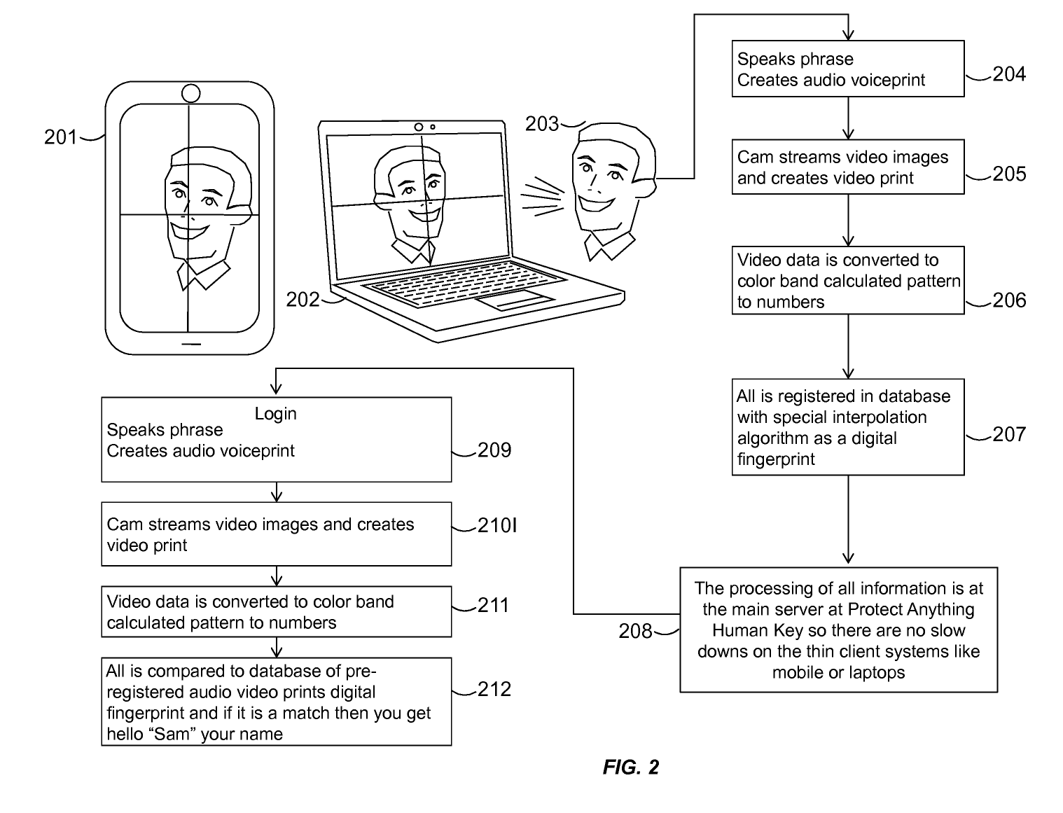

FIG. 2 illustrates the identification process using a mobile device such as a smartphone 201 or a laptop computer 202, PC, or equivalent thin client device. First a user 203 speaks a phrase to create an audio voiceprint 204 into the smartphone 201 or a laptop computer 202, PC, or equivalent thin client device. Next the camera streams video images and creates a video print 205. The video data is converted to a color band calculated pattern to numbers 206. The audio voiceprint, video print, color band calculated pattern to numbers are registered in a database with spatial interpolation algorithm as a digital fingerprint 207. Processing of all audio and video input occurs on a human key system server so there is not usage by the thin client systems used by the user to access the human key server for authentication and verification 208. When a user/person registers in the system an audio and video fingerprint is created, which comprises audio file, video file, image files, text files, and all other files and data that is stored in the database, that are created as reference to who that individual is for the purpose of verification.

To login after creating their registration, first a user speaks a phrase to create an audio voiceprint 209. Next the camera streams video images and creates a video print 210. The video data is converted to a color band calculated pattern to numbers 211. The audio and video is compared to a database of pre-registered audio video prints digital fingerprint and if it is a match then the user is identified and authenticated and provided access to the system and a notification is returned via the thin client system 212.

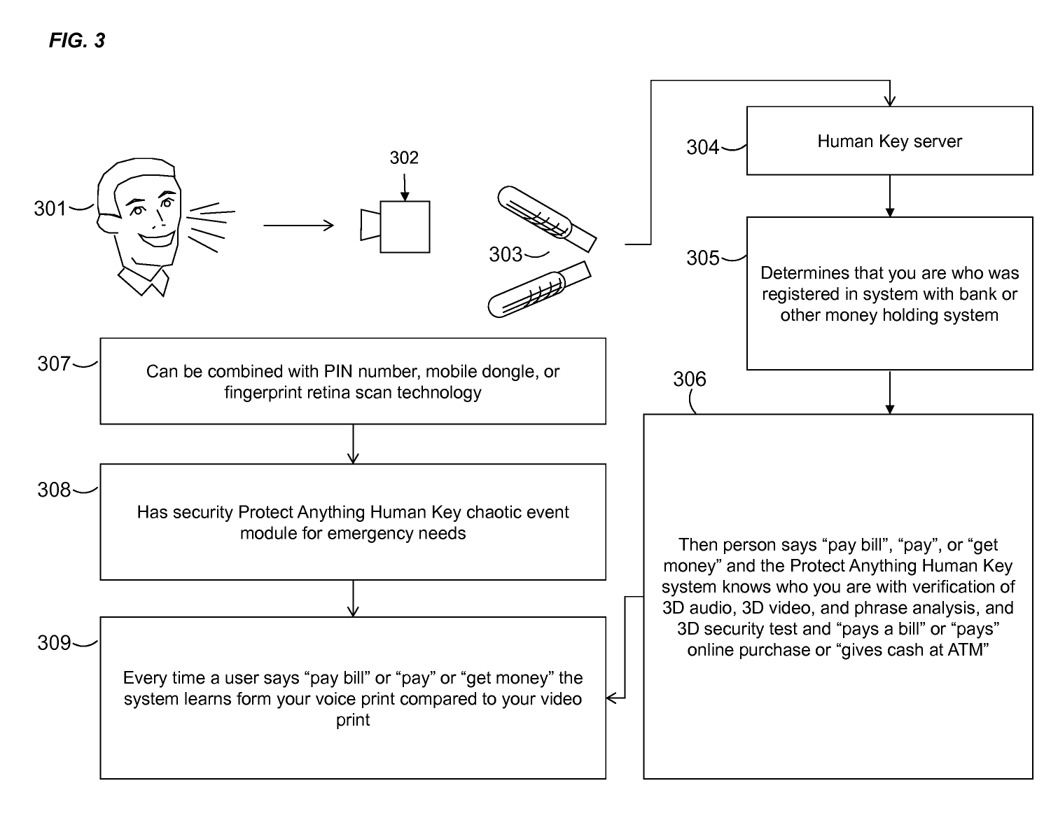

Now referring to FIG. 3, one embodiment of the present invention is illustrated where the user or person 301 uses the method to authenticate a transaction. Using a camera, smartphone, computer, laptop, or thin client device 302, a user 301 first speaks in front of the camera 302 and microphones 303 to create the audio and visual information for verification. The human key server 304 analyses the information as previously disclosed and determines if the user is registered in the system 305. Then person says “pay bill”, “pay”, or “get money” and the human key system knows who a user are with verification of 3D audio, 3D video, and phrase analysis, and 3D security test and “pays a bill” or “pays” online purchase or “gives cash at ATM” 306. Every time a user says “pay bill” or “pay” or “get money” the system learns from their voice print compared to their video print 309. This method can be combined with PIN number, mobile dongle, or fingerprint retina scan technology 307. Additionally, other word patterns of successful logins can be disrupted, by the user, when they login, to send an alert to the authorities, or administrator that something is not right 308.

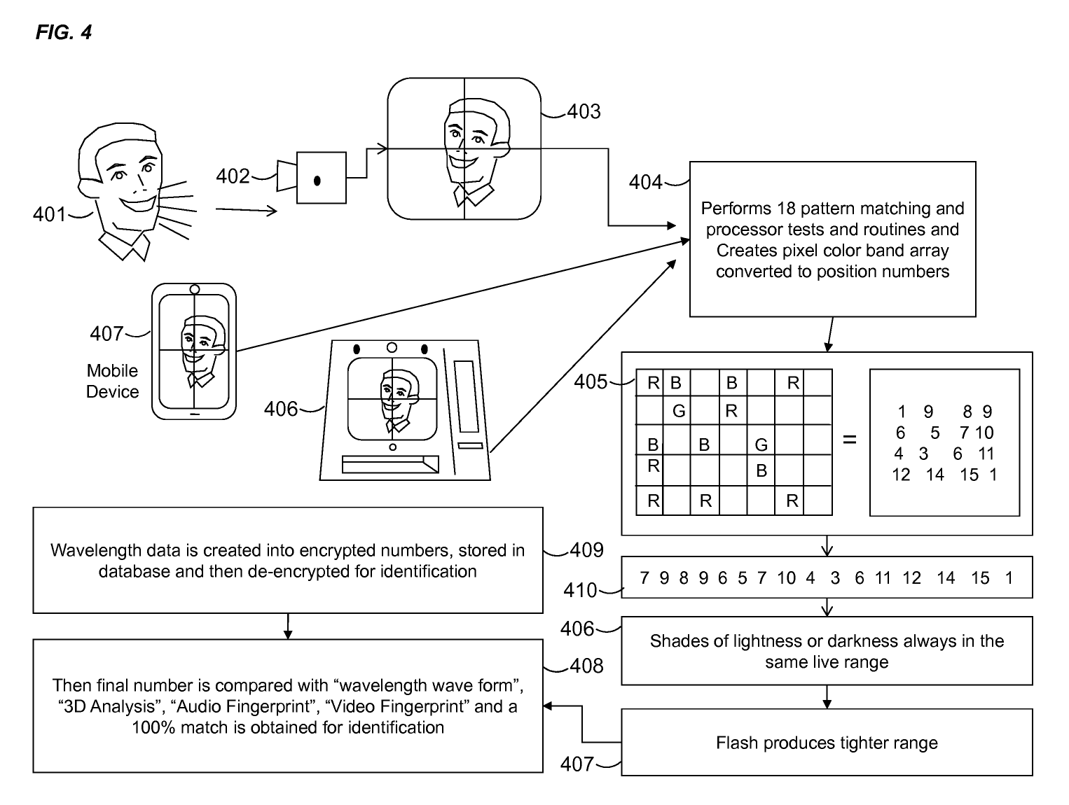

Now referring to FIG. 4, the user's pattern matching process is taught. A user 401 enters audio and video via a camera 402, smartphone 407, ATM 406, or any equivalent machine or thin client device by using the video means of the devices to line up their face with crosshairs 403 to provide image identification. The method of the present invention performs eighteen pattern matching and processor tests and routines 404 and creates a pixel color band array converted to position numbers 405 for the captured image. Wavelength data is created into encrypted numbers, stored in database and then de-encrypted for identification 409. Shades of lightness or darkness are always in the same live range 406 while a flash produces tighter range 407. The final numbers are compared with “wavelength wave form”, “3D Analysis”, “Audio Fingerprint”, “Video Fingerprint” and a match is obtained for identification 408.

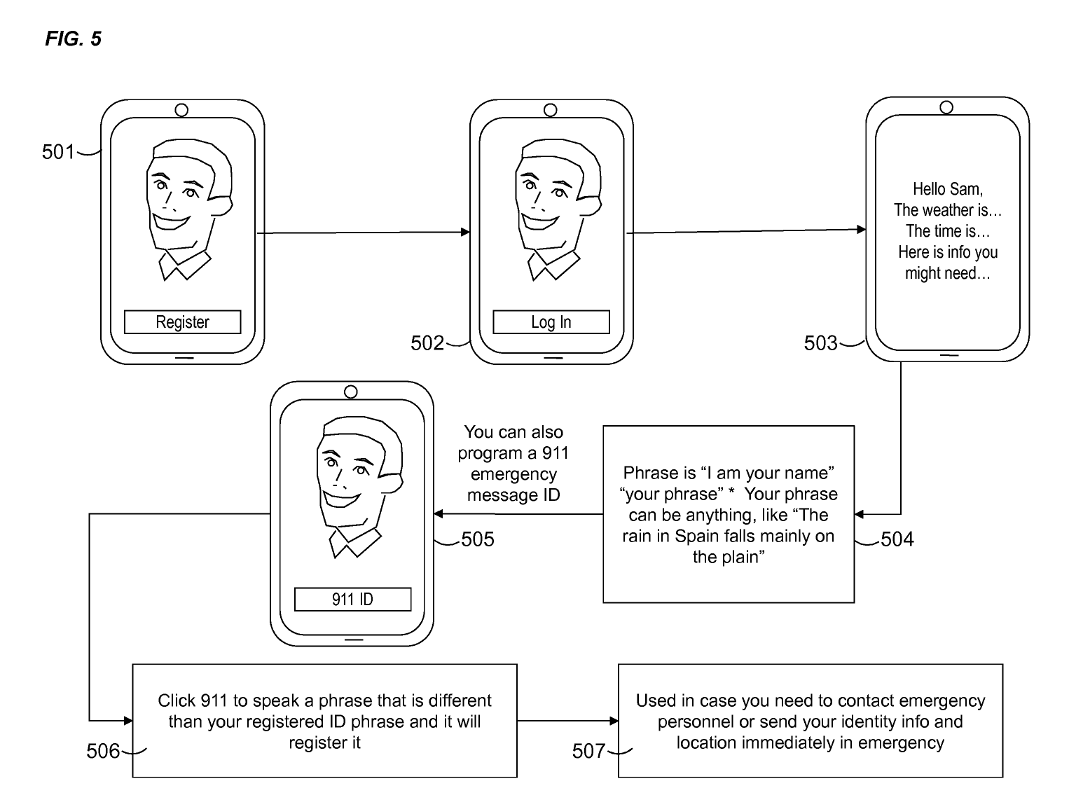

Now referring to FIG. 5 an emergency identification, authentication, and process is taught. After a user registers 501 and logs in 502, they are presented with an information screen 503. Here, a user can elect to register an emergency 911 phrase 504, which is a different phrase than that use for system log-in and identification and access 506. For example, instead of saying “the rain in Spain falls mainly on the plain” a user that is being forced to use an ATM says “the rain in Spain falls mainly on a plain” 504. The second phrase has been pre-programmed by the user as a chaotic event phrase trigger, when signing in to get money out of the ATM. The user records this emergency phrase in the same manner as previously described for the registration and log-in phrase and the same process of recording the audio and video is repeated. This emergency phrase is used in a situation where a user needs to contact emergency personnel and send their identity information and location immediately in an emergency situation 507. The user does not need to be logged in to initiate the emergency feature. All a user needs to do is look at their phone and say the emergency phrase, which automatically identifies them and contacts the appropriate authorities.

While logged into the computer system of the present invention running on a thin client, a user can say “911” and an emergency screen is presented to them on the thin client 505. The user then looks into it and says their emergency phrase 504. Upon verification of the user and the emergency phrase, authorities are called, emailed, notified, and GPS coordinates are sent automatically. This is effective because the emergency people have the name, address and all data a user has about a himself, medical records if stored in the server database and attached to the user's registration and location. Upon arrival on the scene, all a 911 team has to do is talk with a user to identify a user needs. This cuts down on infrastructure, personal costs, and gets help to a user faster. The emergency team can see a user from a user camera and can know where a user are with GPS tracking via a live video stream from the camera on a mobile device or other thin client for emergency assistance.

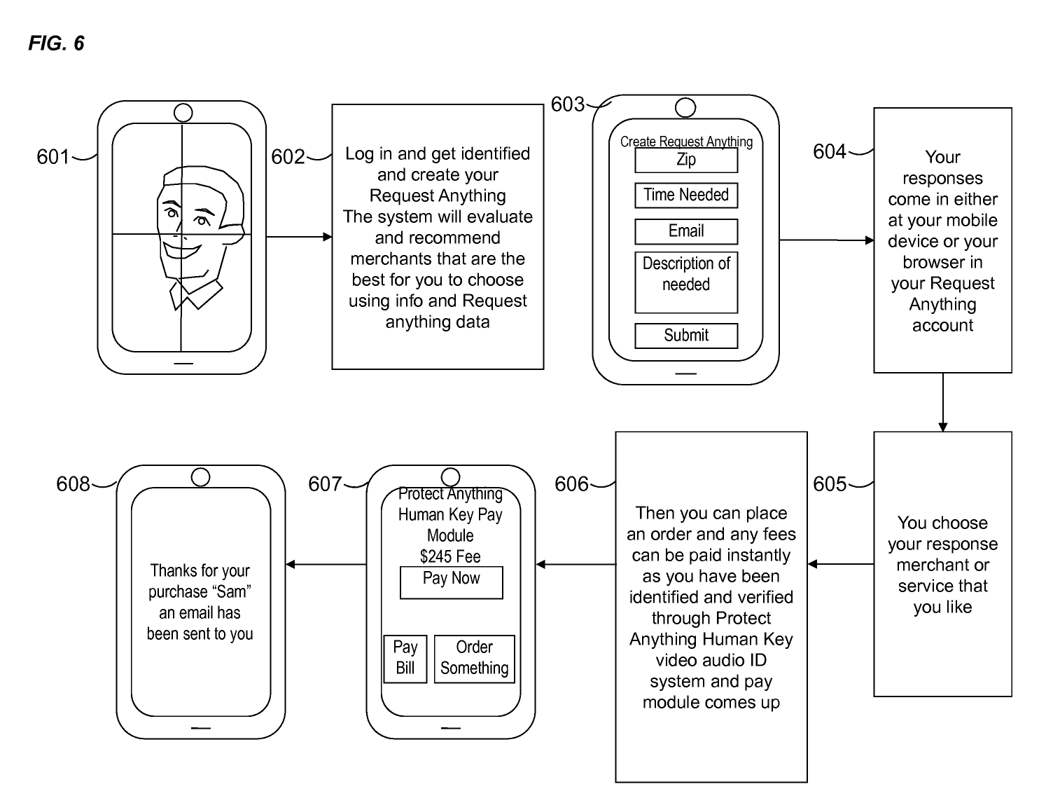

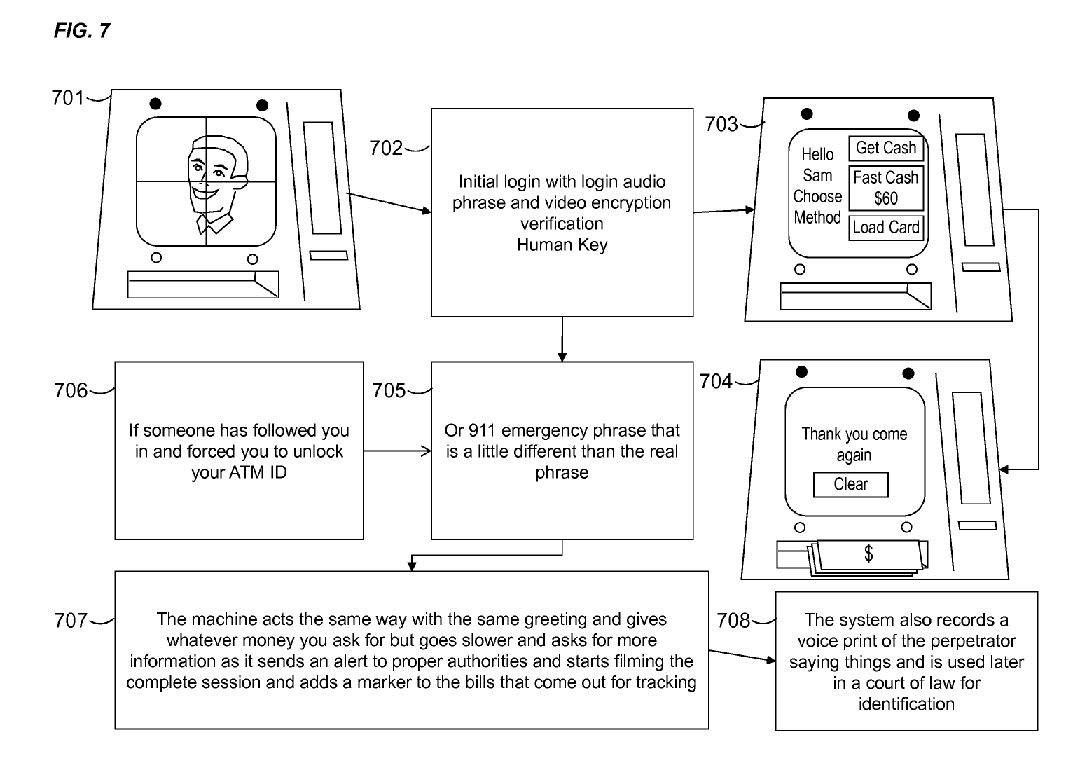

Now referring to FIGS. 6 and 7, the identification and authentication system is used in combination with a purchase method. In a first step the user uses a smartphone or equivalent machine 610 to log in and is identified and creates their request 602. The system will evaluate and recommend merchants that are the best for them to choose using data stored in a database. User responses to input requests such as zip code, email description, and time till purchase are entered on their thin client device 603 and presented either on their thin client device or the browser in their account on the system server 604 and the user chooses the response merchant or service they would like to purchase 605. The user can place an order and any fees can be paid instantly as they have been identified 606 and verified through the human key video audio ID system and the pay module is then displayed 607 for them to confirm the transaction. Upon confirmation, and confirmation screen is displayed and an email or other confirmation notice generated and sent to the user 608.

In another embodiment illustrated in FIG. 7, an emergency 911 phrase can be used in combination with the transaction and purchase process. By registering a 911 phrase that is different, but similar enough to an actual transaction phrase 705, a user being forced to enter into a transaction 706. A user approaches an ATM machine and 701 and begins the initiating login with login audio phrase and video encryption verification 702. The ATM displays the standard options screen 703 and transactions screen 704. The machine acts the same way with the same greeting and gives whatever money the user ask for but goes slower and asks for more information as it sends an alert to authorities and starts filming the complete session and adds a marker to the bills that come out for tracking 707. The system also records a voice print of the perpetrator saying things and is used later in a court of law for identification 708.

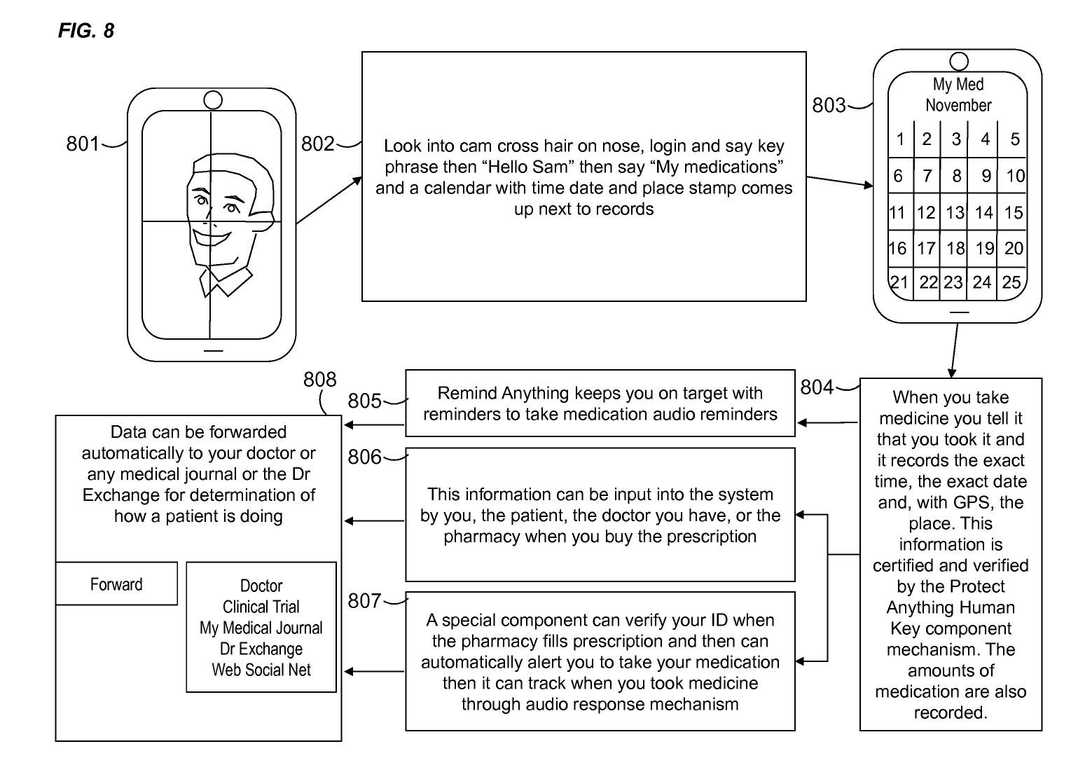

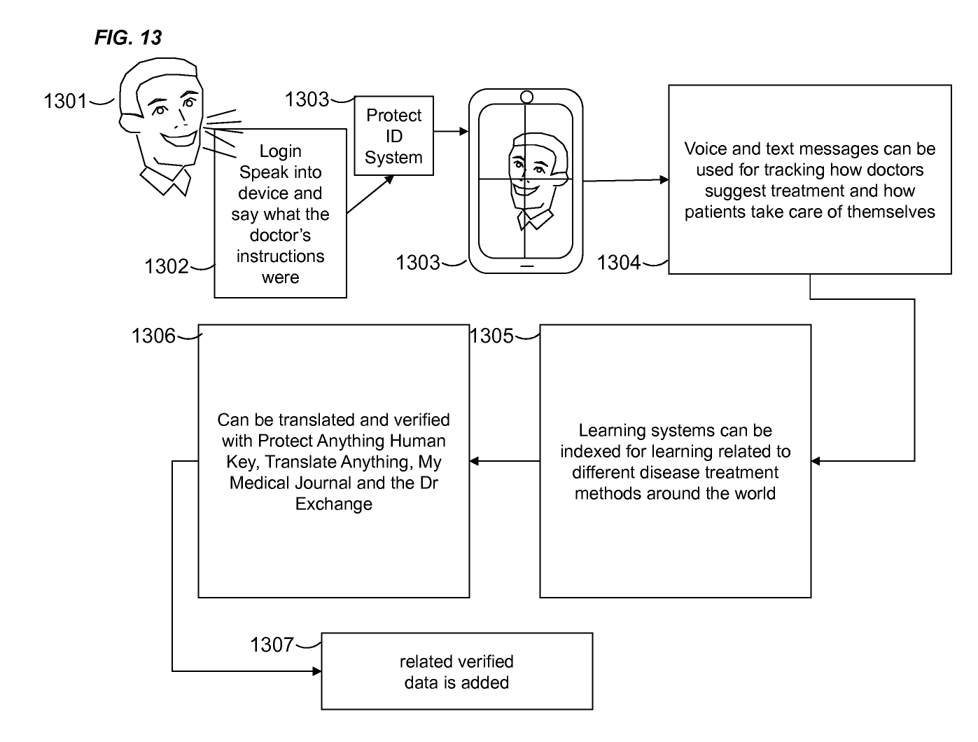

Now referring to FIGS. 8-13 a medical journal embodiment of the method for identification and authentication is provided. First a user looks into a camera and aligns the cross hair on their nose 801, login and says a key phrase such as “My medications” 802 and a calendar 803 with time date and place stamp comes up next to records. When a user take medicine a user tell it that a user took it and it records the exact time, the exact date and, with GPS, the place 804. This information is certified and verified by the human key. The amounts of medication are also recorded. The present invention keeps a user on target with reminders to take medication audio reminders 805. This information can be input into the system by a user, the patient, the doctor, or the pharmacy when a user buys a prescription 806. A spatial component can verify a user ID when the pharmacy fills prescription and then can automatically alert a user to take a user medication then it can track when a user took medicine by audio input confirmation from the user 807. Data can be forwarded automatically to a user doctor or any medical journal or the Dr Exchange for determination of how a patient is doing 808.

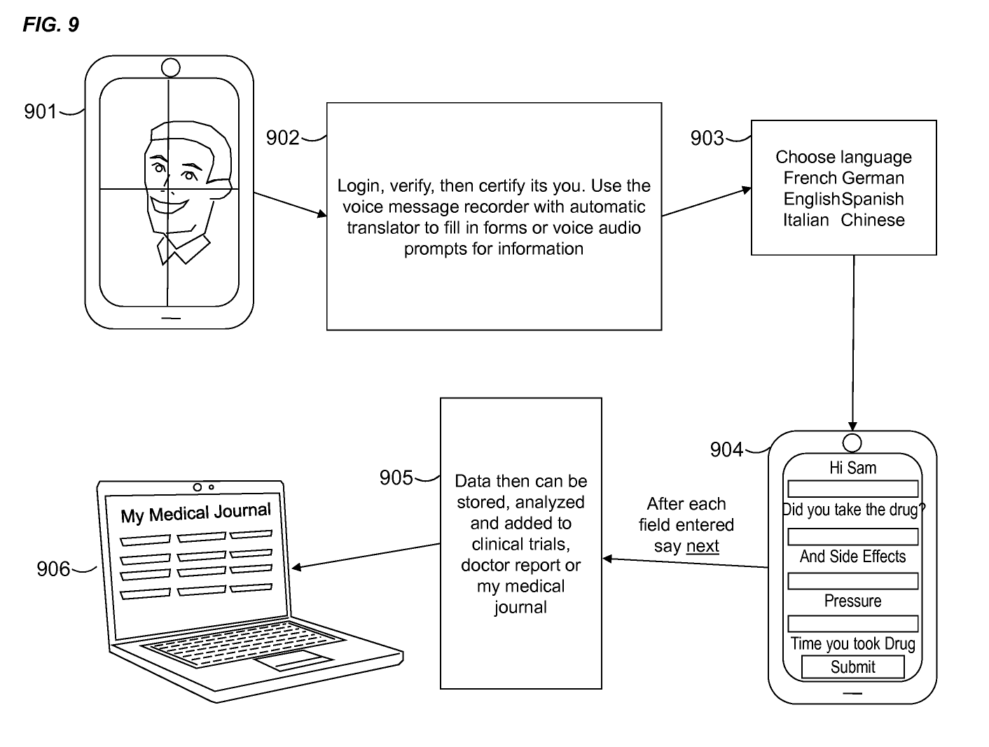

Now referring to FIG. 9, first a user logs-in to verify, then certifies their identity 902 using a smart phone or other device 901. The user uses the voice message recorder to select a language 903 and fill in forms or voice audio prompts for information 904. Data then can be stored, analyzed, and added to clinical trials, doctor report, or a user's medical journal 905. Upon completion the user's medical journal is displayed 906.

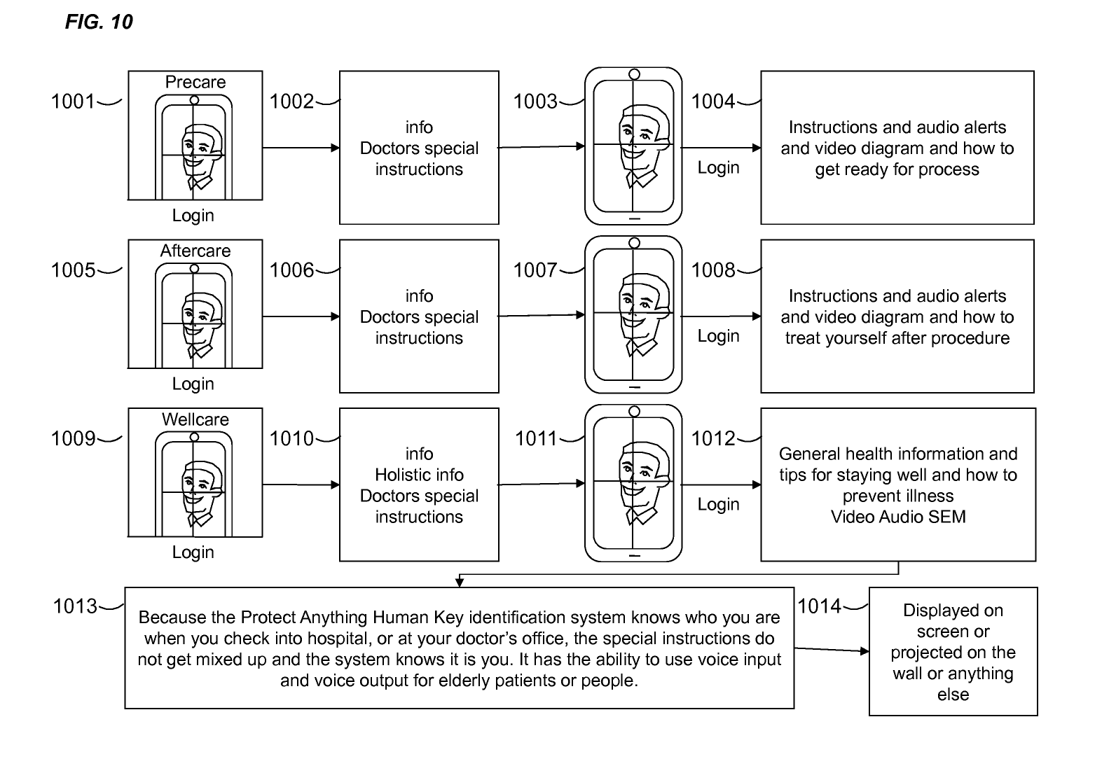

Now referring to FIG. 10, for Precare, Aftercare, and Wellcare situations 1001, 1005, and 1009, a user can login 1003, 1007, and 1011 and receive instructions and audio alerts and video diagrams related to how to get ready for an upcoming medical event such as a doctor visit, blood work, or surgery 1004, how to take care of themselves after the medical event 1008, and general health information and tips for staying well and how to prevent illness can be provided in audio or video format and displayed on the screen of the users device 1012. Because the human key identification system knows who a user is when a user check into hospital, or at a user doctor's office, the spatial instructions 102, 1006, and 1010 are tailored to the individual user 1013. The system has the ability to use voice input and voice output for elderly patients or people as well as display the information on a screen or projected on a wall 1014.

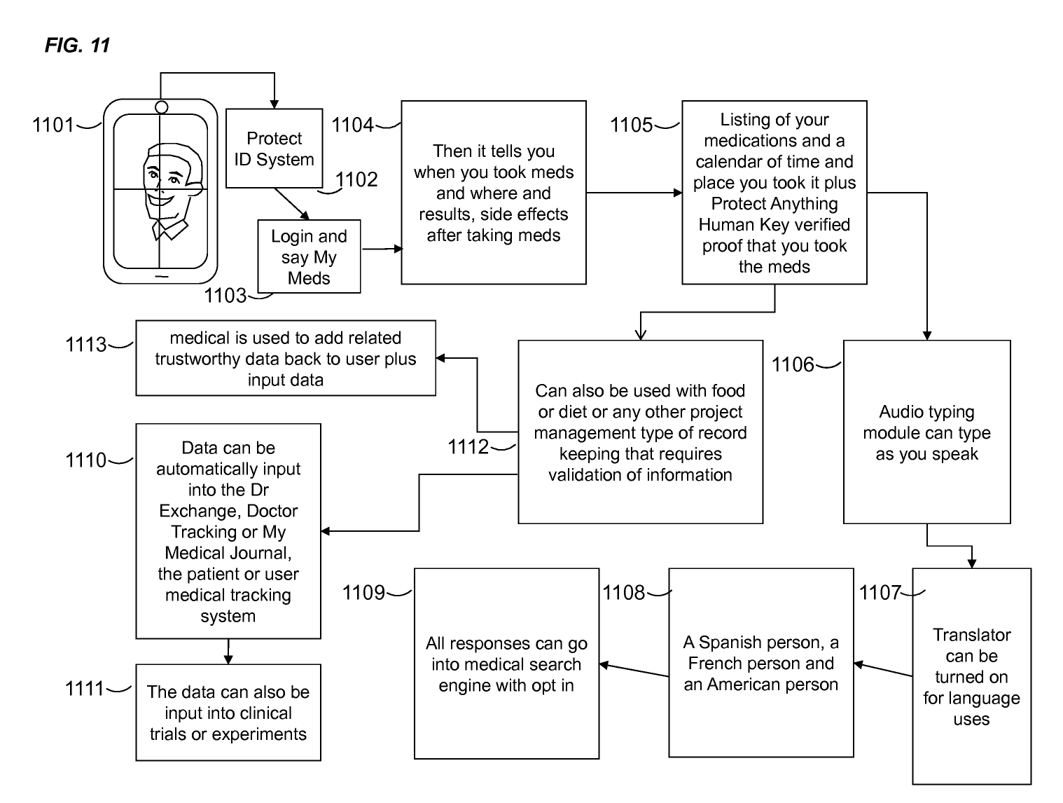

Now referring to FIG. 11, the human key for identification and authentication is shown in combination with a medical journal and information exchange with other registered uses such as doctors. First a user logs in 1103 to the system 1102 by using a smartphone or other device 1101. Next the using an audio verbal command requests their medications be repeated a registered phrase. The system them returns information telling the user when they took their medication, the location and time, and any results or side effects previously recorded 1104. The system also lists the user's medication and a calendar of time and locations of when and where they were taken, which is verified by the entry of the information using the login and human key verification method 1105. The system is further comprised of an audio typing module that converts spoken works into text 1106 and a language translator that can translate spoken words into translated text 1107 for various users 1108. All responses and entries are stored in a user's medical database 1113 and can also be into a medical research database base if opt in is selected by the user 1109. This method can also be used with food, diet, or any other management type of record that requires record keeping and validation of the information 1112. Data can be automatically input into the Dr Exchange, Doctor Tracking or My Medical Journal, the patient or user medical tracking system 1110. The data can also be input into clinical trials or experiments 1111.

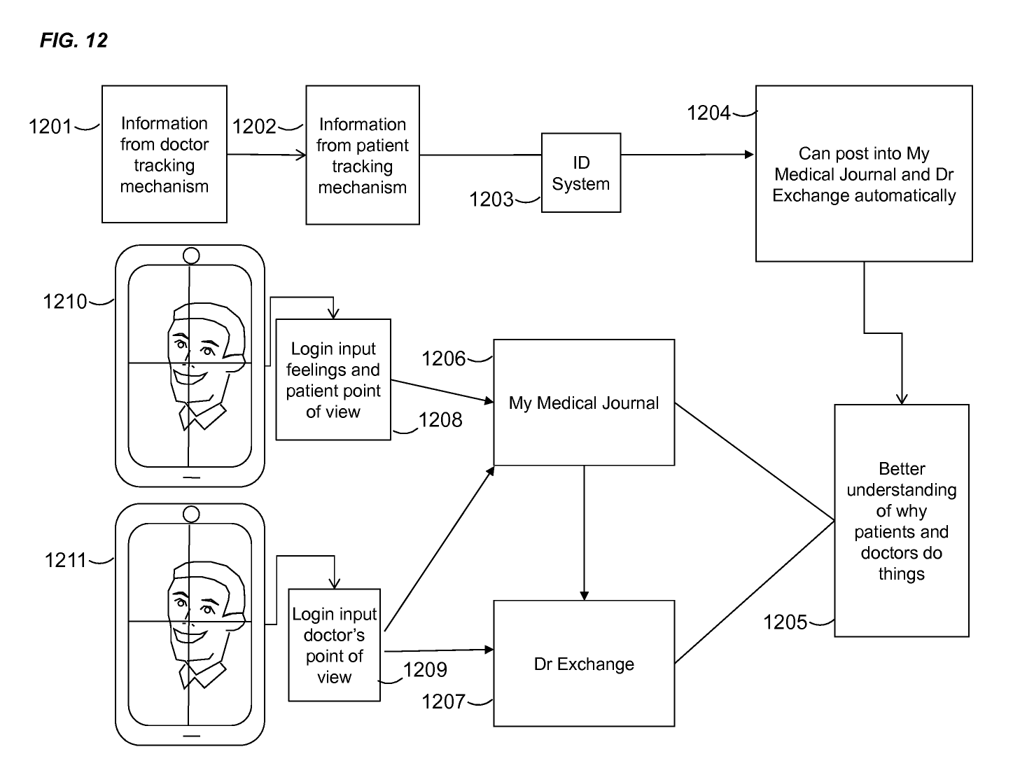

As shown in FIG. 12, the information from a doctor's database 1201 and a user's database 1202 can both be identified by the human key identification system 1203 and posted or stored in a user's medical journal and/or to a Dr. Exchange where access and distribution of the information can be limited to authenticated and identified users 1204. In this embodiment, a user could log their feeling or personal information using a first device 1210 from their perspective into the system for review by a doctor 1208 into their medical journal 1206, a doctor could then use a device 1211 to login could then provide feedback from their (the doctor's) perspective that can be stored as notes on the patient 1209 and shared with the patient/user through the exchange 1207 resulting in a better understanding of why patients and doctors are taking certain actions or what is causing them 1205.

After an appointment, a user 1301 can login 1302 to the system 1303 using a device 1303 and record what the doctor's instructions were for a specific course of action 1304. The user can then use voice and text messages for tracking how the user/patient takes care of themselves, and through the exchange, doctors can track how suggested treatments or actions are occurring for an individual user and compare that to groups of users under the same orders to see if the orders can be better tailored or executed to obtain the desired results. Learning systems can be indexed for learning related to different disease treatment methods around the world 1305. Additionally, the information can be translated and verified with the human key and added to a medical journal and the Dr. Exchange 1306 in addition to related, verified data 1307.

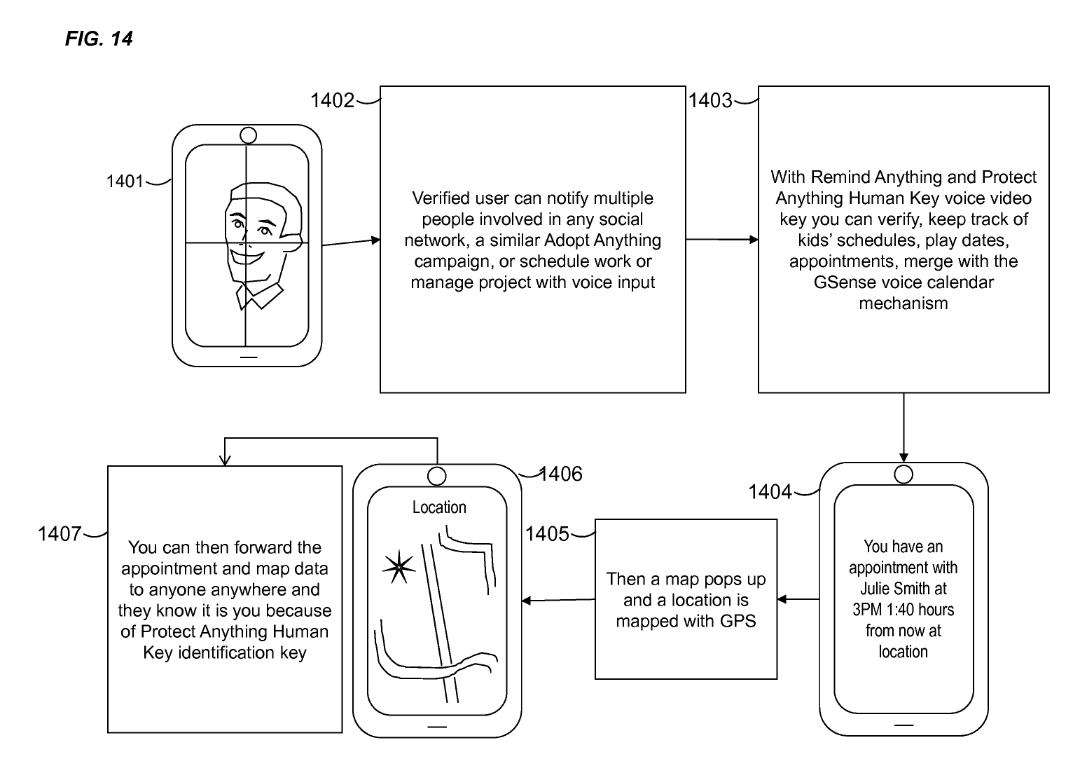

Now referring to FIG. 14, a verified user login using a device 1401 and notify multiple people involved in any social network, a similar campaign, or schedule work or manage project with voice input by using the method and system and previously discussed 1402. By using the audio and video identification method, a user can verify, keep track of kids' schedules, play dates, appointments, and merge them with a calendar 1403. The calendar can then provide notifications of appointments 1404 in addition to directions 1405. The user can then forward the appointment and map data 1406 to anyone anywhere and the recipient will know it was sent by the authenticated user because of the human identification key 1407.

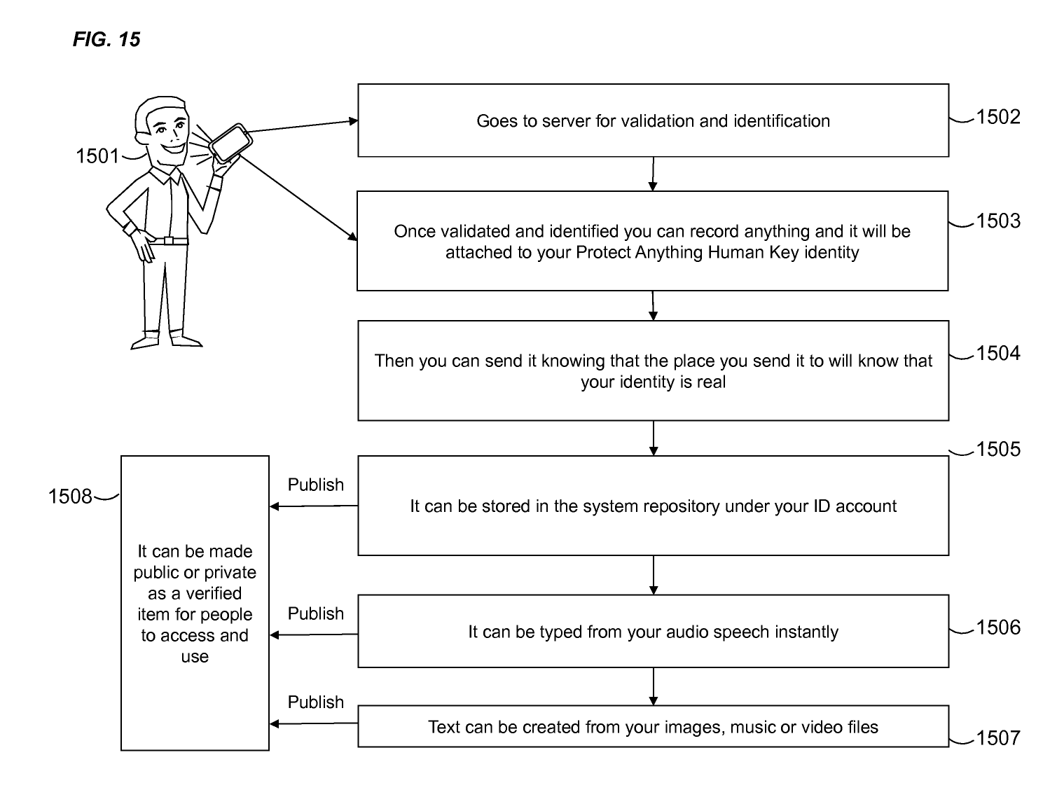

FIG. 15 is a flow chart illustrating the speaking, publishing, and storage steps in the method. First a user enters audio and video input via a thin client device 1501 for validation and identification 1502. Once validated and identified, the user can record anything and it will be attached to their human key identity 1503. The use can then send any attached information and the recipient will know that the transmission is legitimate and authenticated by the system 1504. The information can be stored on a system server under the human key ID and user account 1505. Audio input can be transformed into written text for publication 1506, and text can be created from images, music, or video for publication 1507. The information can then be published publicly or privately as a verified and authenticated item for people to access and use 1508.

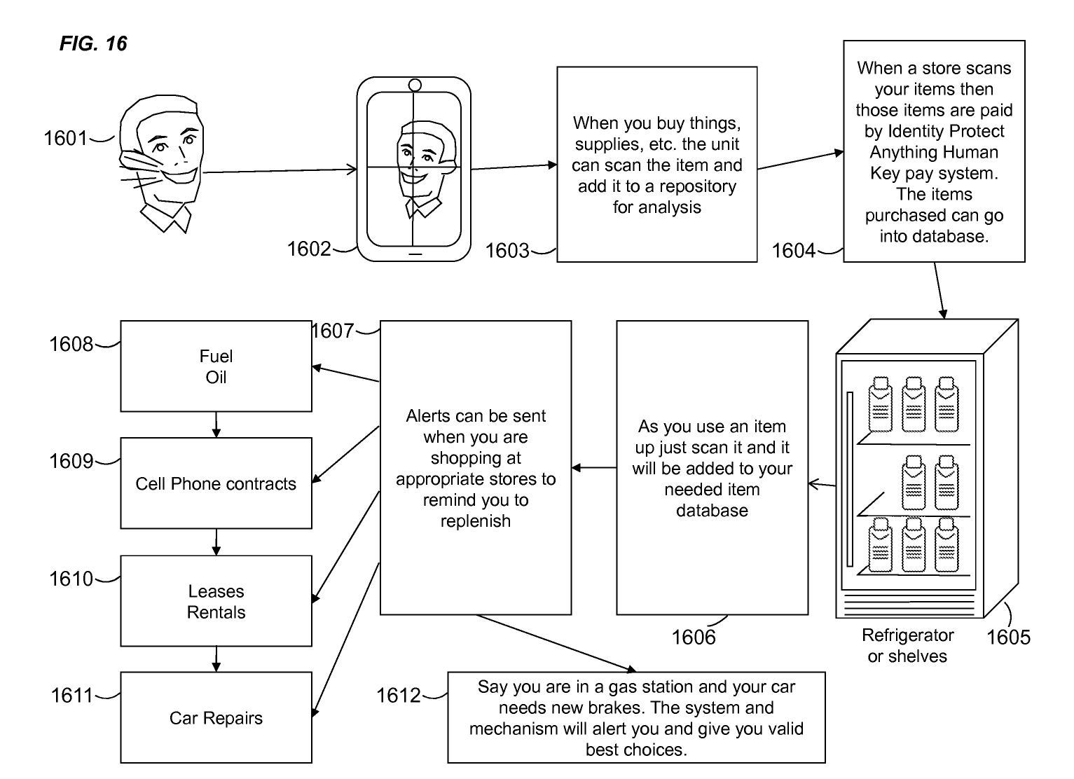

FIG. 16 illustrates a tracking and alerting feature of the method of the present invention. A user 1601 enters audio and visual information for identification and verification as previously taught into a device 1602. When the user wants to make a purchase, they use their thin client device to scan the item and add it to their database for later analysis 1603 such as a product on a store shelf 1605. When a store scans the items, those items are paid for by using the human key in combination with the pay system previously taught and the purchased items are stored in a database 1604. As the items are used, they are re-scanned and noted as used and the system adds them to a needed item database for replenishment 1606. Alerts can be generated and sent to a user when they are shopping at appropriate stores to remind them to purchase replenishments 1607. This can be done for physical items such as fuel oil 1608, car repairs 1611, leases and rentals 1610, or contractual commitments such as with a cell phone 1609. If a user were in a gas station and their car needs new brakes, the system would alert them and give the valid best choice options 1612.

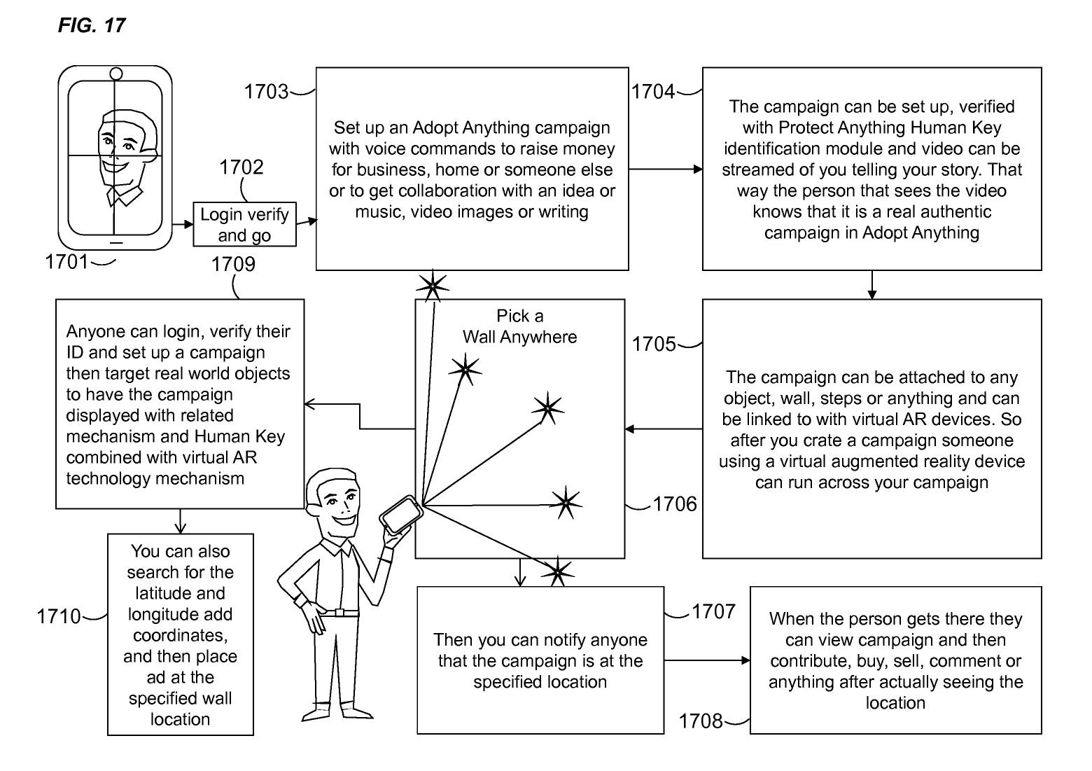

FIG. 17 illustrates an embodiment of the method of the present invention as applied to campaigns. First a user 1701 logs in 1702 to verify their identity as previously taught. Next the user sets up a campaign with voice commands to raise money or to collaborate on a project 1703. The campaign can be set up, verified with the human key identification and video can be streamed of a user telling a user story 1704. This way the person that sees the video knows that it is a real authentic campaign in the system. The campaign can be attached to any object, wall, steps or anything and can be linked to with virtual augmented reality devices such as a recorder projector or a thin client device equipped with projection means 1705. So after a user creates a campaign someone using a virtual augmented reality device can run a user campaign audio, video, or images at any location 1706. The system can also be integrated to an advertising system where a user could search for the locations of advertising displays and then select a specific location and have their information an ad displayed 1710. The user can notify anyone that the campaign is at the specified location 1707.

In a practical situation the mobile phone projects an infrared point and calculates the vertical horizontal and depth of that point, utilizing GPS or spatial point targeting if there is no GPS 1706. Then when another user gets a signal or walks by the wall, if the advertising message is attached to that spatial point, then an ad, text, message, video, or any media can be played in the mobile device. This can also be human key related as the message can not only be given at a specific spatial point, but it might need to be an authorized message, which would be identified and authorized to the recipient before taking delivery or the recipient identified and authorized before transmitting for delivery to the recipient 1709. When the person gets there they can view campaign and then contribute, buy, sell, comment or anything after actually seeing the location 1708.

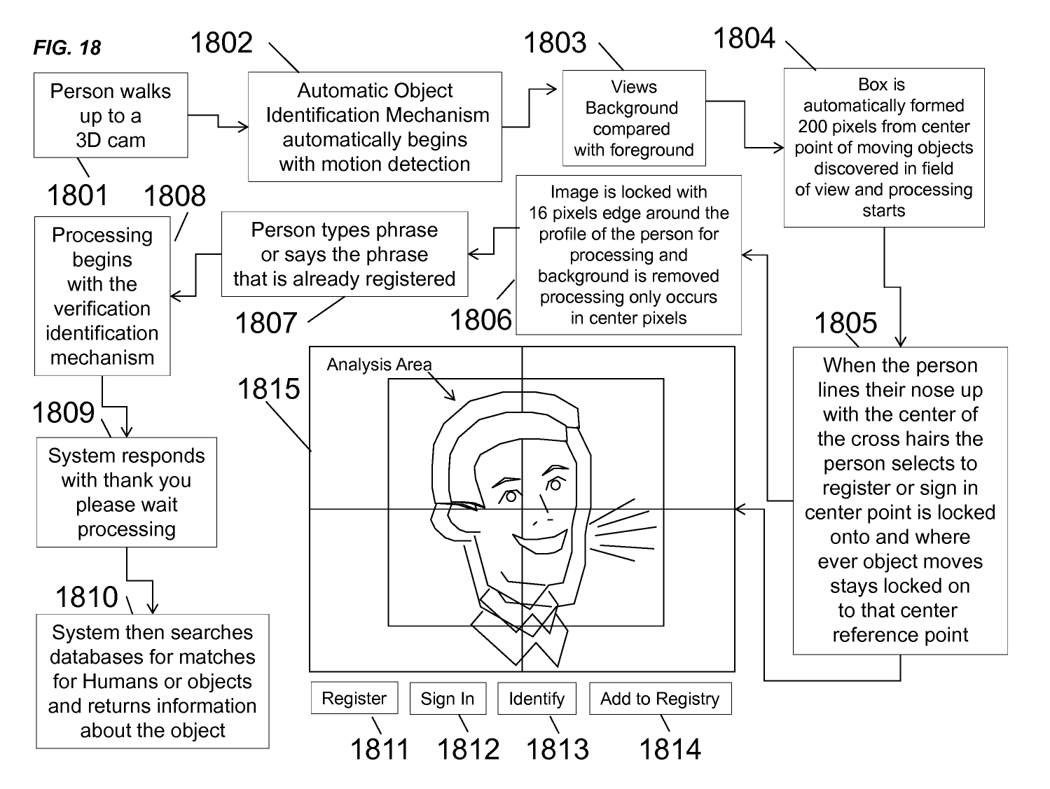

Now referring to FIGS. 18-21, the verification method of the present invention is disclosed. First, a person approaches a 3D camera or uses a 3D camera integrated into a thin client device such as a smartphone, pad computer, laptop, pc, or equivalent device 1801. Automatic Object Identification automatically begins with motion detection 1802. The background is compared with the foreground 1803. A box is automatically formed 200 pixels from center point of moving objects discovered in field of view and processing starts 1804. When the person lines their nose up with the center of the cross hairs in the analysis area 1811, the person selects to register 1811 or sign in 1812 center point is locked onto and where ever object moves stays locked on to that center reference point 1805. Additionally a user could add an item to their registry 1814, or identify an item 1813 by making either of those selections and continuing the process. The image is locked with 16 pixels edge around the profile of the person for processing and background is removed processing only occurs in center pixels 1806. Next, the user types a phrase or says the phrase that is already registered 1807. Processing begins with the verification and identification of the submitted phrase 1808. The system may provide a message while processing occurs 1809. Finally the system searches the database for matches and return information about the object 1810.

In identification of a human object the method needs to have protection from a user making a 3D model and putting it before the ATM and the system needs to be able to identify a live human object versus a fake human object, so this aspect would determine what the object is. The way to identify live humans, is that they are fluid not static and three dimensional, and with spatial reference points calculated in the background, a machine can identify fluid or static object.

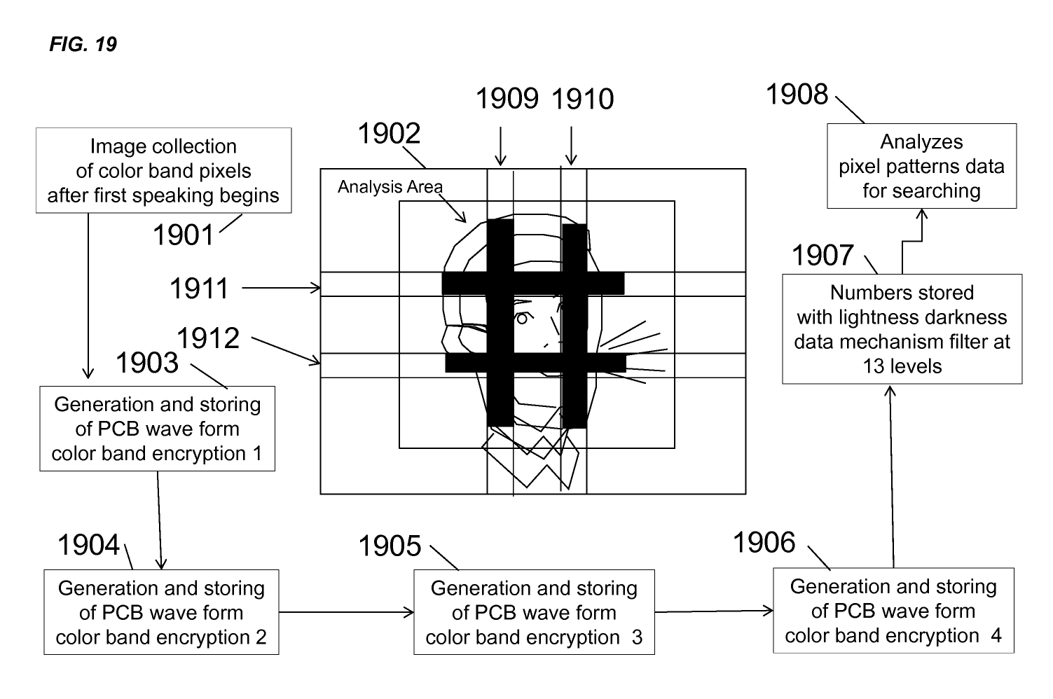

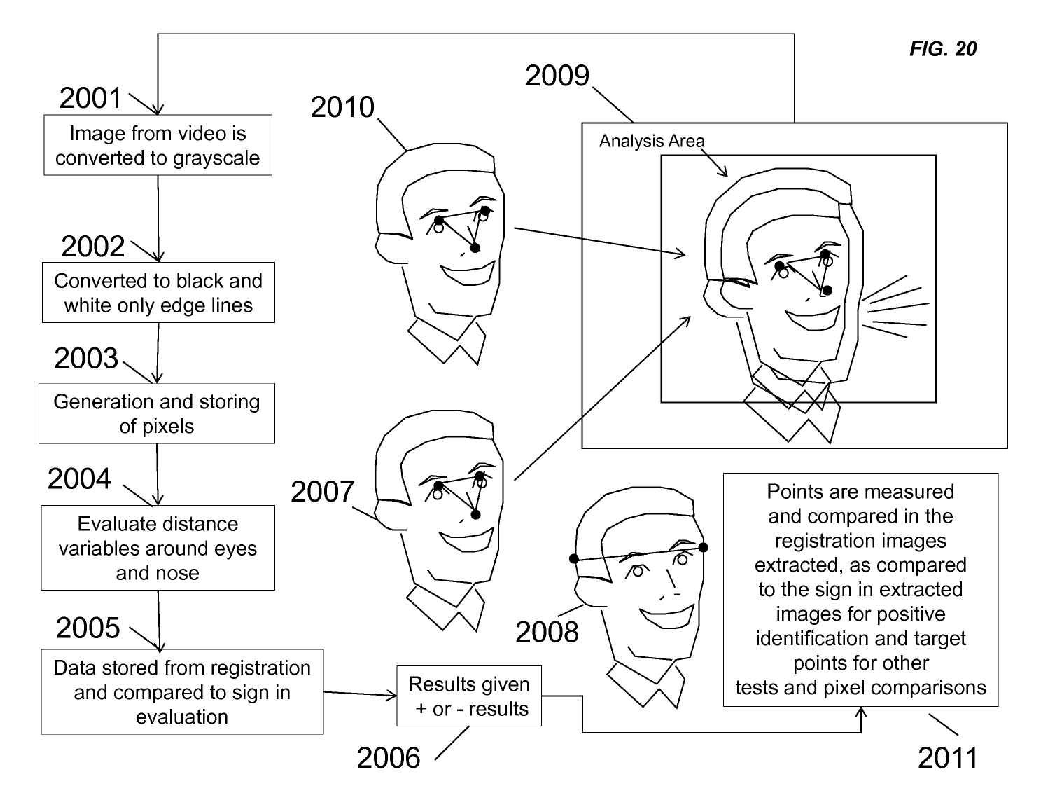

FIGS. 19-20 illustrate the until pixel color band wave form encryption process. First an image collection of color band pixels occurs after the first phrase is spoken 1901. Color bands 1909, 1910, 1911, and 1912 and the analysis areas 1902 are determined. A first generation and storing of pixel color band (PCB) wave form occurs in a first encryption 1903 and is repeated for four encryption cycles 1904, 105, and 1906. Numbers stored with lightness and darkness values is filtered at 13 levels 1907 and pixels patterns data is analyzed for searching 1908.

Next the image captured from the video input analysis area 2009 is converted to grayscale 2001 and to black and while with only edge lines 2002. Pixels are generated and stored again 2003. Evaluation distance variables around eyes and nose are determined 2010. Points are measured and compared in the registration images extracted 2007 and 2008, as compared to the sign in extracted images for positive identification and target points for other tests and pixel comparisons 2004. Data stored from registration is compared to sign in during an evaluation step. Data is compared to determine if it is from the same human or object 2005. Results are generated and provided 2006. Points are measured and compared in the registration images extracted 2007 and 2008, as compared to the sign in extracted images 2010 for positive identification and target points for other tests and pixel comparisons 2011. A match combined with 9 out of 17 positive point evaluations returns “Hello, and a user first name”. A non match returns negative point evaluation.

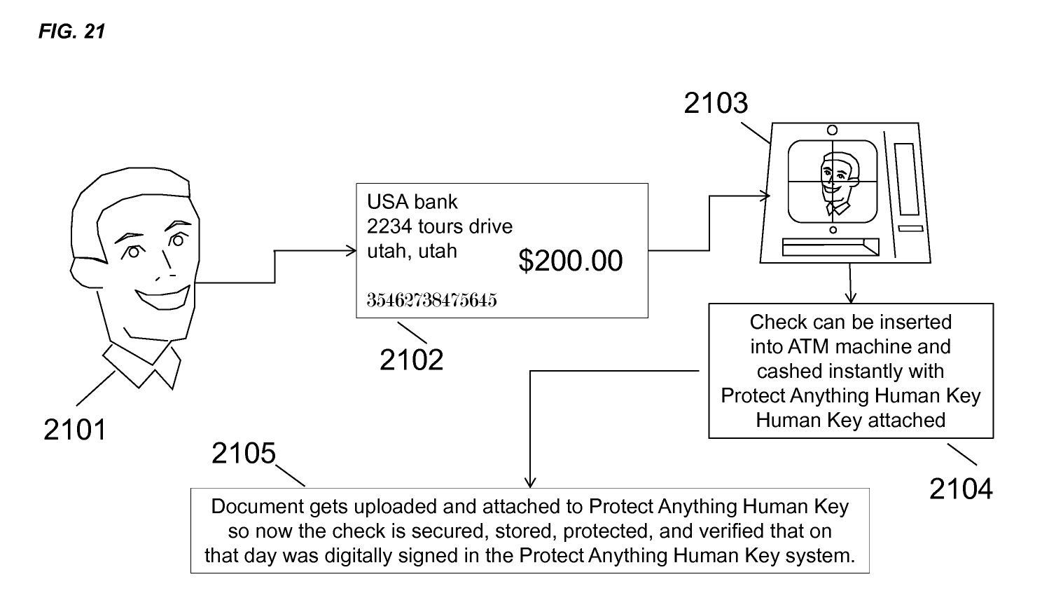

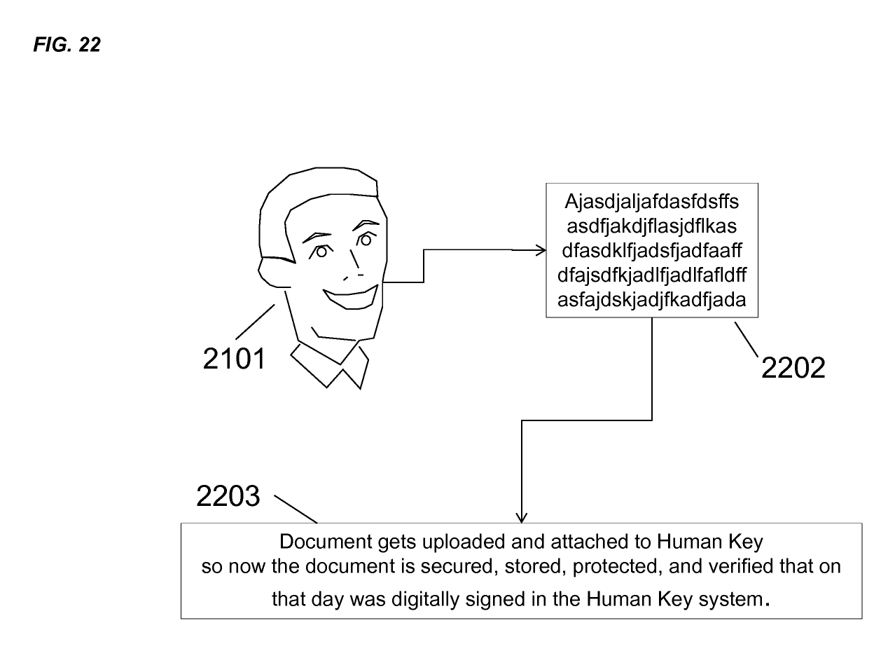

FIGS. 21-25 illustrate an embodiment of the present invention with respect to financial transactions. In one embodiment, the human key used for identification and authentication of a user or person 2101 is used when a check 2102 is inserted into an ATM machine 2103 and cashed instantly 2104. The check image document gets uploaded and attached to the human key used for identification and authentication so now the check is secure, stored, and protected and verified that on that day was digitally signed in the human key system 2105. The document/check is uploaded and attached to the human key so now the document is secured, stored, protected, and verified that on that day it was digitally signed 2202 in the human key system 2203.

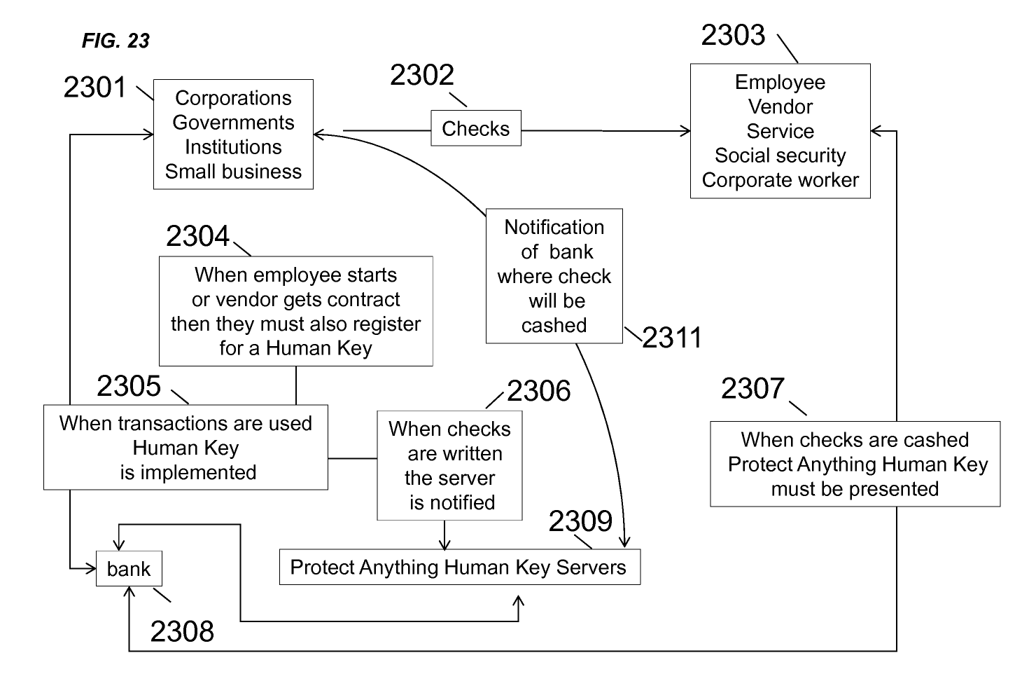

Now referring to FIG. 23, when a legal entity such as a corporation, government, or small business issues 2301 checks 2302 to employees or suppliers 2303, the issuer registers the issuance of the check with the human key system. When the checks 2302 are cashed, a human key 2305 must be presented with the checks 2302 to verify that person cashing the check is the recipient or representative of the recipient 2307. Thus, a recipient must also be registered in the system with their own human key 2304. Upon receipt of a check 2302, the bank 2308 accesses the human key server 2309 to confirm the human key 2305 and notifies the issuing party 2301 of the check 2302 where the check 2302 will be cashed. The human key servers 2306 then confirm the issuance of the check 2302, and the identity and authentication of the presenter 2303 of the check 2302 to the bank 2308 and notify the bank 2308 if the issued check 2302 is authentic and if the presenter 2303 of the check 2302 is authentic. The bank 2308 then uses this information to make a decision on whether to cash the check 2302 and its action is recorded in the human key system 2309 and sent to the issuer of the check 2301.

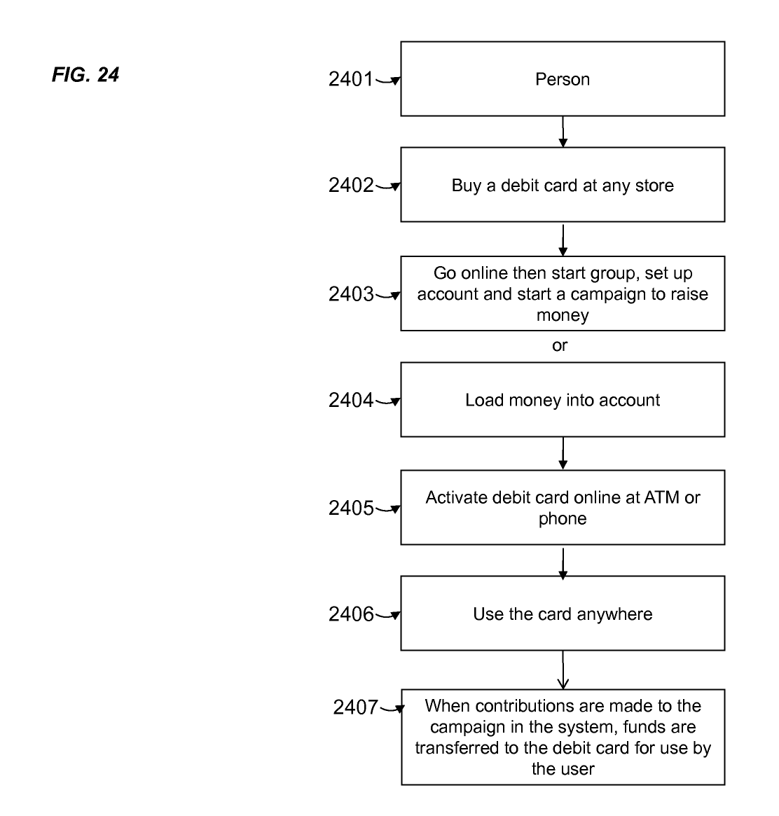

FIG. 24 teaches the use of the human key in a debit card embodiment. First a user 2401 buys a debit card from any seller 2402. The user then logs in to the system and initiating a campaign as previously taught and set up an account to raise money that is tied to the purchased debit card 2403 or they load money into the account 2404. The debit card is activated 2405 and they can use the card anywhere it is accepted 2406. When contributions are made to the campaign in the system, funds are transferred to the debit card for use by the user 2407.

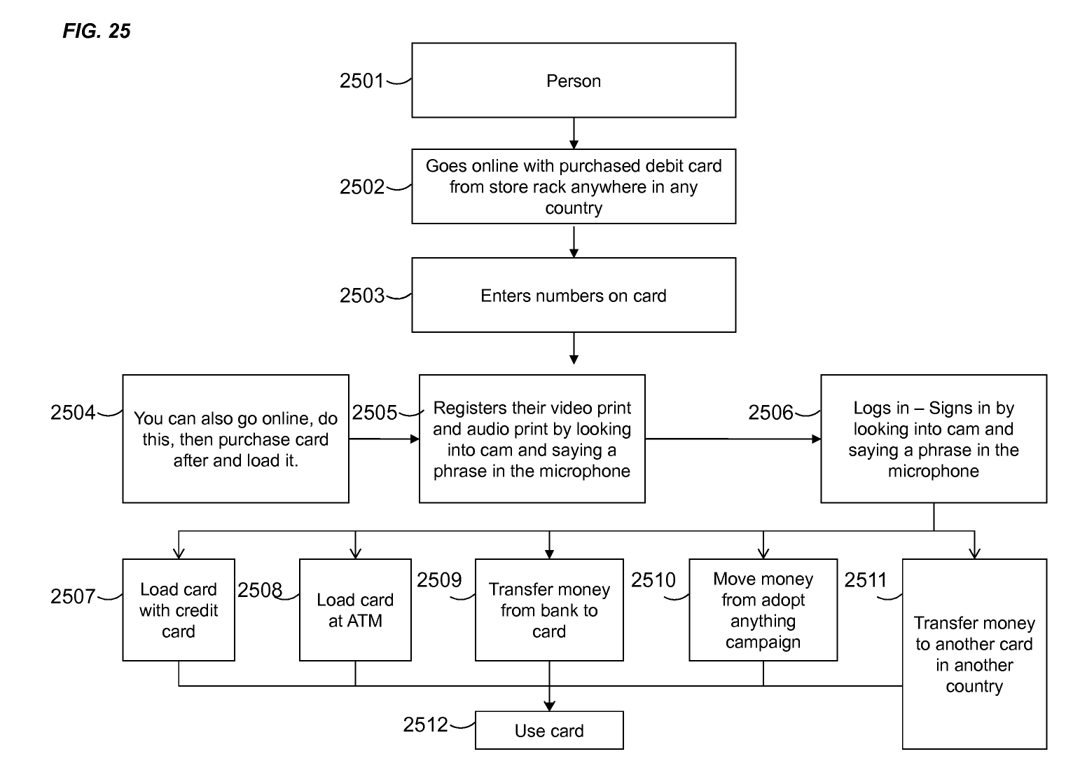

FIG. 25 illustrates the use the audio video human key notification system with respect to a credit or debit card. First, a user 2501 goes online with a purchased debit card 2502 and enters the card number in the human key system 2503. Next the user registers their video and audio print by looking into a camera and saying a phrase as previously taught 2505. Registration can occur before or after a card is purchased 2504. Upon completion of log-in or registration 2506, the user can transfer money form a bank to the card 2509, load the debit card from a credit card 2507, and load the card from an ATM 2508, move money from a campaign in the system to the card 2510, or transfer money to another card in another country 2511.

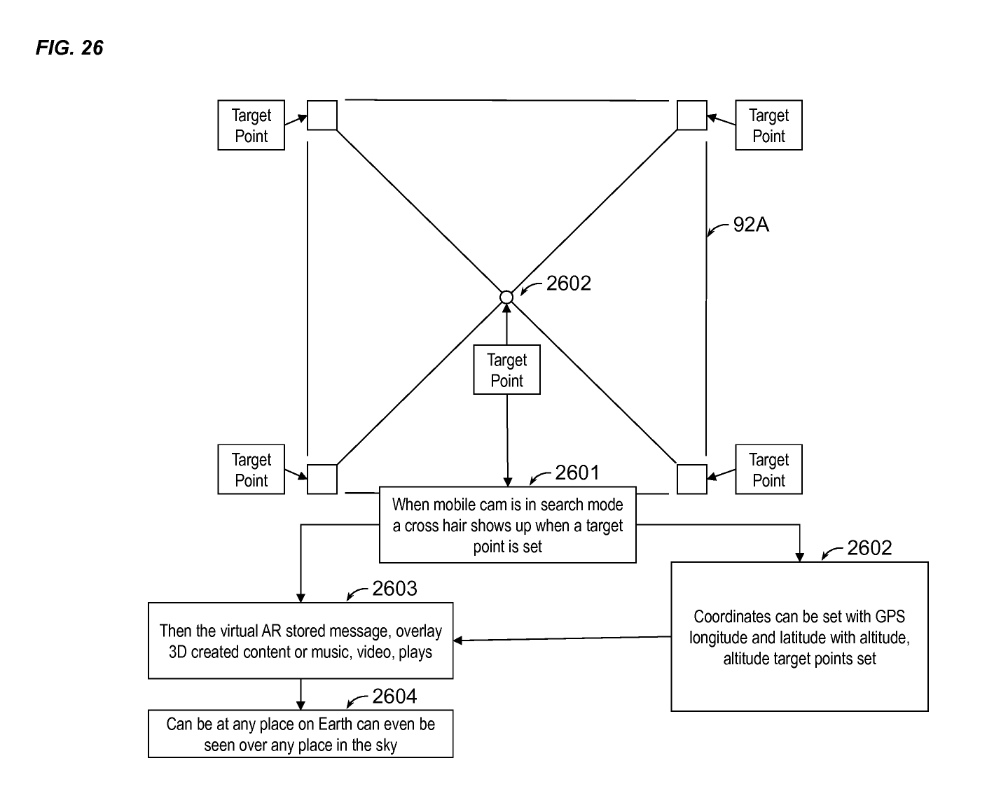

Now referring to FIG. 26, when a mobile cam is placed into a search mode, a cross hair shows up when a target point 2601 it set 2601. Coordinates can be set with GPS longitude and latitude with altitude. With altitude target points set, the virtual AR stored message, overlay 3D created content or music, video, plays 2603. The virtual AR stored message, overlay 3D created content or music, video, plays can be at any place on Earth can even be seen over any place in the sky 2604.

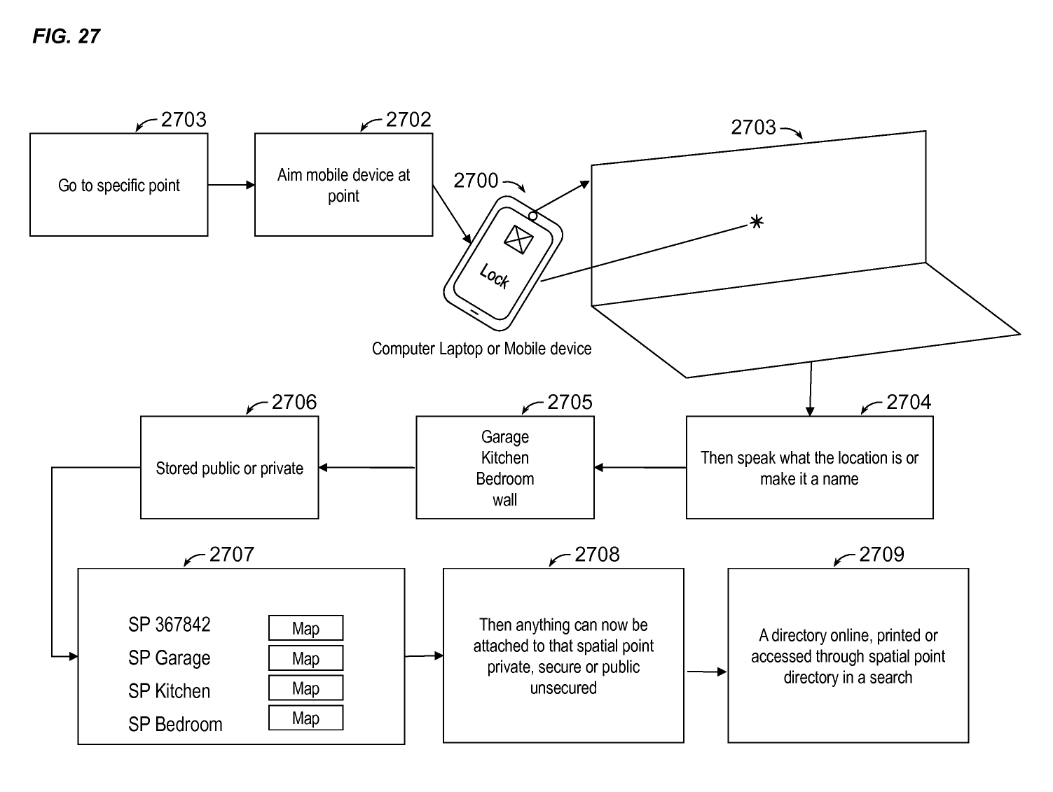

Now referring to FIG. 27, a device 2700 is taken to a specific point 2701 and the device is pointed at the spatial point 2702 such as a point on an object 2703. Next the user speaks the location 2704 or gives it a name 2705 and decides if this will be a public or private location 2706. The spatial points are located on a map 2702 and the user can then attach anything to that spatial point for viewing in a public, private, secured, or unsecured manner 2708. A directory online, printed, or accessed through a spatial point directory search is then created and/or updated 2709.

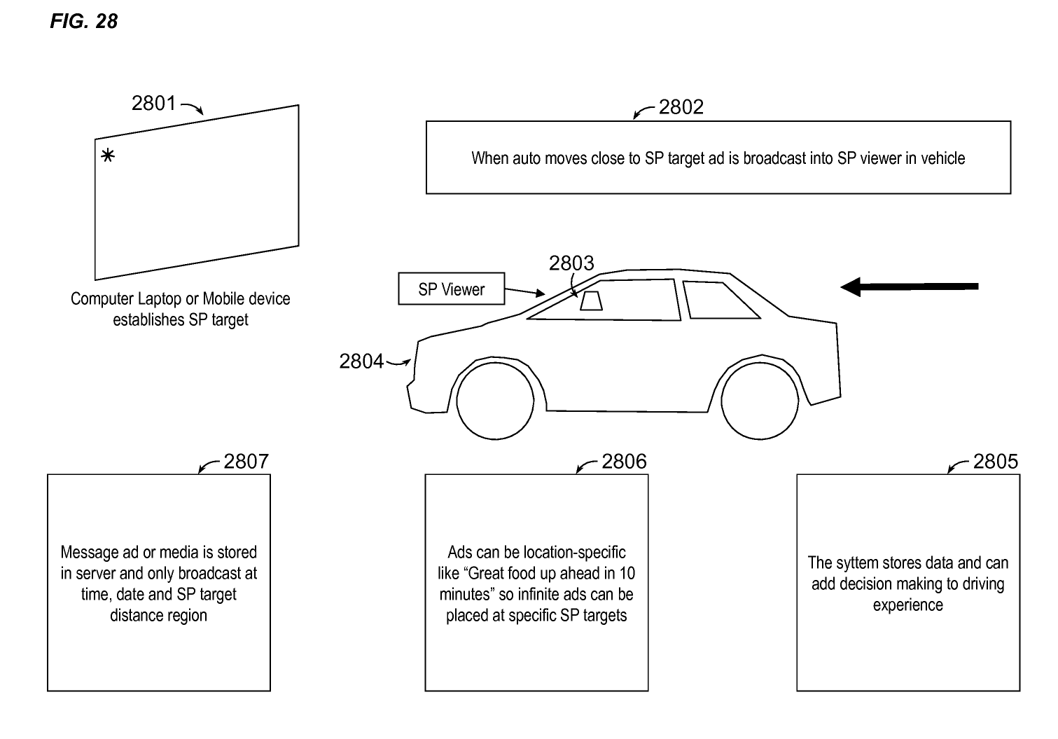

Now referring to FIG. 28, a device established a target point 2801. When a moving vehicle such as an automobile moves close to the target point, an advertisement is broadcast 2802 to the viewer in a vehicle 2804 using a display device 2803 located in the vehicle 2804.

The system stores data and can add decision making to driving experience 2805. Ads can be location-specific like “Great food up ahead in 10 minutes” so infinite ads can be placed at specific spatial point targets 2806. Message ad or media is stored in server and only broadcast at time, date and spatial point target distance region 2807.

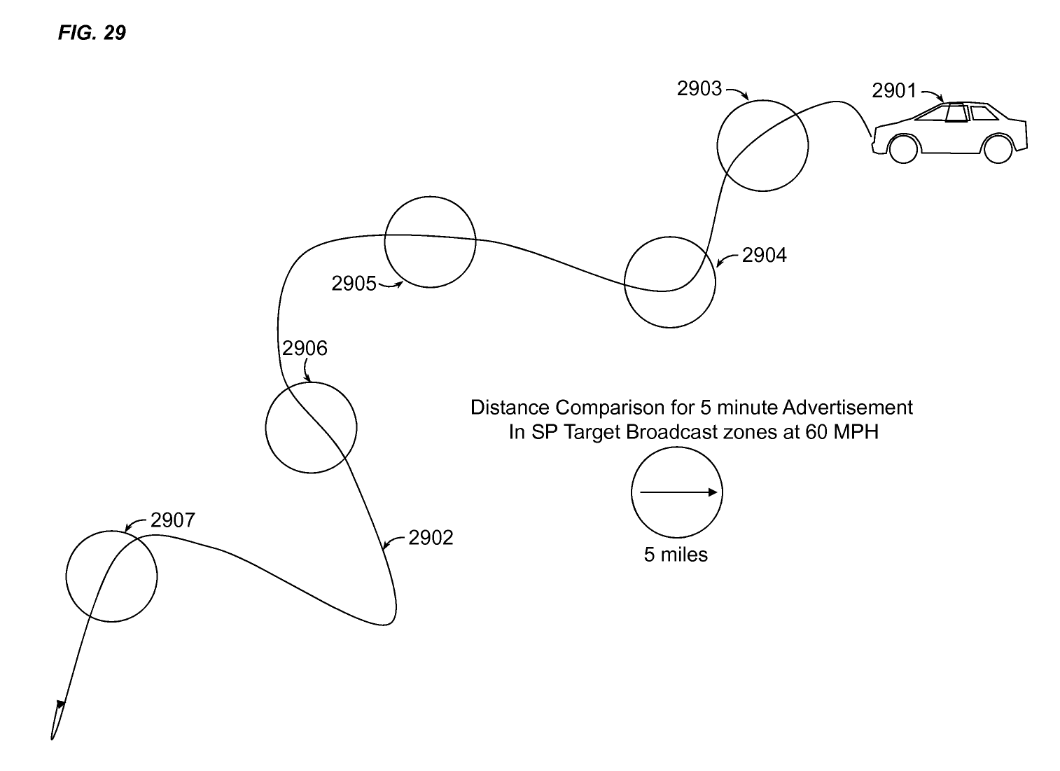

Now referring to FIG. 29, as a vehicle 2901 travels along a path 2902, it will pass a plurality of spatial point targets 2903-2907. When the vehicle 2901 is within a specific range, her five miles for a vehicle traveling at 60 MPH, of the spatial point targets 2903-2907 the message is delivered to a display device located within the vehicle 2901, or mobile devices traveling in the vehicle 2901.

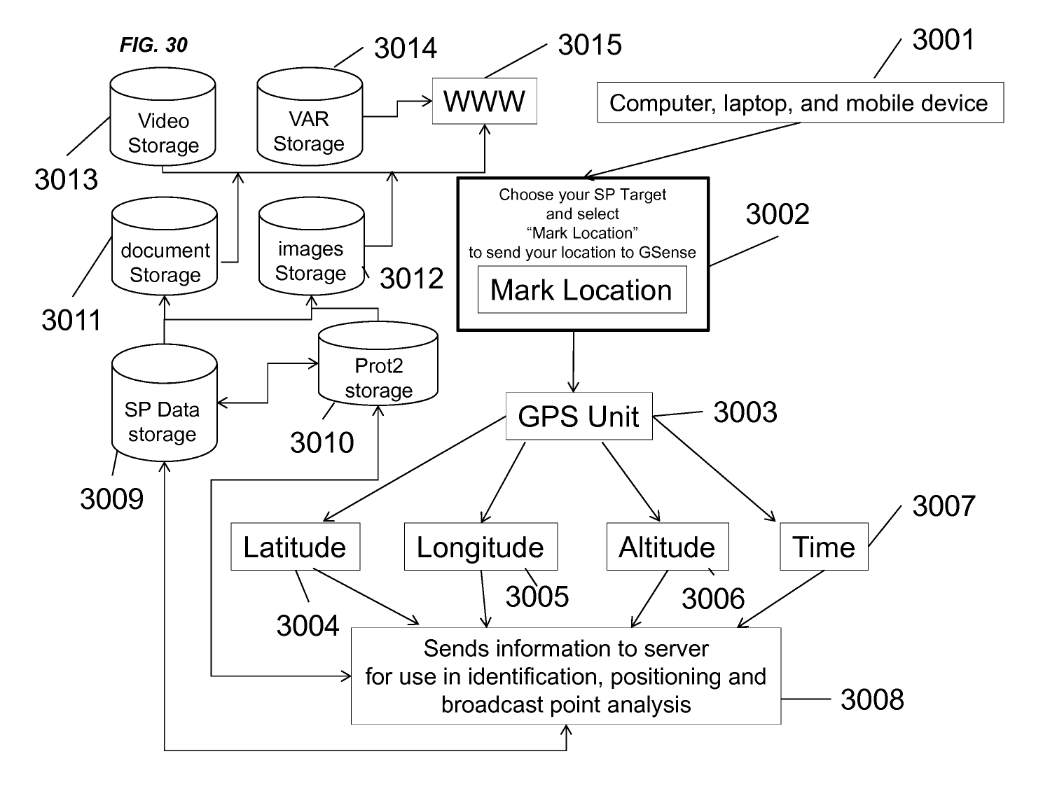

Now referring to FIG. 30, Using a mobile device 3001, a user marks the spatial point target where they want their content delivered then selects mark location and the location is identified for the delivery 3002 by a GPS unit 3303 within the mobile device that records time 3007, altitude 3006, longitude 3005, and latitude 3004. This information is sent to the system server for use in identification, positioning, and broadcasting point analysis 3008. Data is stored in databases 3009 and 3010. Documents and images are stored in separate databases 3011 and 3012 while video and VAR information are stored separately in their own databases 3013 and 3014 for transmission via the Internet or world wide web 3014.

Moreover, other implementations of the invention will be apparent to those skilled in the art from consideration of the specification and practice of the invention disclosed herein. Various aspects and components of the described embodiments may be used singly or in any combination in the computerized content filtering system. It is intended that the specification and examples be considered as exemplary only, with a true scope and spirit of the invention being indicated by the following claims.

Although the present invention has been described in considerable detail with reference to certain preferred versions thereof, other versions are possible. Therefore, the point and scope of the appended claims should not be limited to the description of the preferred versions contained herein.

As to a further discussion of the manner of usage and operation of the present invention, the same should be apparent from the above description. Accordingly, no further discussion relating to the manner of usage and operation will be provided.

With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

The embodiments of the invention in which an exclusive property or privilege is claimed are defined as follows:

1. A method for identification and authentication of a user and protecting information executed by a machine, comprising the steps of:
recording audio and visual input of a user including recording visual background information by a recording device;
comparing two recording device results;
analyzing the camera results in an overlay pixel pattern analysis;
calculating the position of a forward focused object;
calculating the position and depth of background focused object;
determining the difference between the first and second values;
generating a preliminary 3D security decision;
creating an audio voice print at the same time as the video calculation;
determining distance by audio voiceprint and assigning a distance value;
comparing the calculated position of the forward focused object to the distance determined by the audio voiceprint;
making a final security decision on whether the object is a real live 3D person or it is a non-live person or object; and
and creating a human key comprised of audio and visual fingerprints.

2. The method of claim 1, further comprising the steps of:
recording a user speaking a phrase to create an audio voiceprint into a device;
streaming the video images;
creating a video print;
converting the video data to a color band calculated pattern to numbers;
calculating an audio voiceprint, video print, and color band number pattern;
registering the number in a database using an interpolation algorithm;
creating a digital fingerprint;
creating an audio and video fingerprint when a user registers, which comprises one or more of an audio file, video file, image file, or a text file;
storing the audio and video fingerprint in a database;
using the stored audio and video fingerprint as reference to who that individual user is for the purpose of verification.

3. The method of claim 2, wherein the recording device is a mobile device, a smartphone, a laptop computer, personal computer, or thin client device.

4. The method of claim 2, wherein processing of all audio and video input occurs on a system server for authentication and verification.

5. The method of claim 2, comprising the following steps to login after creating a registration:
speaking a phrase to create an audio voiceprint;
streaming video images;
creating a video print;
converting the video data to a color band calculated pattern to numbers;
comparing the audio and video to a database of pre-registered audio video prints and digital fingerprints;
identifying and authenticating a user if there is a match;
providing access to the system; and
returning a notification to the user device.

6. The method of claim 5, further comprising the steps of:
authenticating a transaction;
creating audio and visual information for verification by a device;
analyzing the information to determine if the user is registered in the system;
identifying the user with verification of 3D audio, 3D video, and phrase analysis, and 3D security test;
providing an audio or text statement to conduct a financial transaction; and
processing a financial transaction.

7. The method of claim 6, further comprising the step of:
combining identification and authorization with a PIN number, mobile dongle, or fingerprint retina.

8. The method of claim 2, further comprising the steps of:
Lining up a user face with crosshairs on the video and audio recording device to provide image identification;
performing eighteen pattern matching and processor tests and routines;
creating a pixel color band array converted to position numbers for the captured image;
creating wavelength data that is encrypted into numbers, stored in database and then de-encrypted for identification;
providing shades of lightness or darkness are always in the same live range while a flash produces a tighter range;
comparing the final numbers with “wavelength wave form”, “3D Analysis”, “Audio Fingerprint”, “Video Fingerprint”; and
obtaining a match for identification.

9. The method of claim 2, further comprising the steps of:
electing to register an emergency 911 phrase, which is a different phrase than that use for system log-in and identification and access;
pre-programming the second phrase as a chaotic event phrase trigger, when signing in initiate a financial transaction;
recording the emergency phrase in the same manner as registration and log-in phrase;
inputting the emergency phrase via a recording device;
automatically identifying the user from the emergency phrase;
generating and sending notifications and GPS coordinates provided by the recording device to authorities; and
providing medical information to emergency personnel; and
providing a live video stream from the recording device to authorities.

10. The method of claim 1, further comprising the steps of:
logging in and identifying a user;
creating a purchase request;
entering responses to input requests;
recommending merchants to fulfill the purchase using data stored in a database;
selecting a merchant or service;
placing an order and paying any fees instantly;
displaying a transaction confirmation; and
generating a confirmation notice sent to the user as a receipt.

11. The method of claim 9, further comprising the steps of:
approaching an ATM machine;
beginning the initiating login with login audio phrase and video encryption verification;
displaying an options screen and transaction screen on the ATM;
entering the emergency 911 phrase;
starting video recording by the device during the incident;
causing the ATM to run slower; and
sending an alert to authorities.

12. The method of claim 1, further comprising the steps of:
looking into a camera;
aligning the cross hair with a user's nose;
saying a key phrase;
displaying a calendar with time date and place stamp comes up next to medical records;
recording type, amount, time, date, and location data when a user takes medicine;
providing reminders to take;
storing usage and medical information for a medication, when a user buys a prescription;
verifying when a user ID when the pharmacy fills prescription;
automatically alerting a user to take a user medication;
tracking when a user took medicine;
forwarding data to a user doctor;
saving data in a medical journal; and
publishing data to a data exchange for determination of how a patient is doing.

13. The method of claim 12, further comprising the steps of:
using a voice message recorder to fill in forms;
selecting a language;
storing data to be analyzed and added to clinical trials, doctor reports, or a user's medical journal;
displaying an updated user's medical journal upon data storage.

14. The method of claim 12, further comprising the steps of:
receive instructions and audio alerts and video diagrams for precare, aftercare, and wellcare situations;
tailoring information and instructions to be sent and received by a user based on their identification;
receiving instructions and audio alerts and video diagrams related to how to get ready for an upcoming medical event; and
receiving health information and tips for staying well and how to prevent illness.

15. The method of claim 12, further comprising the steps of:
logging in to the system;
using an audio verbal command requests their medications be repeated a registered phrase;
returning information telling the user when they took their medication, the location and time, and any results or side effects previously recorded;
listing the user's medication and a calendar of time and locations of when and where they were taken;
providing an audio typing module that converts spoken works into text and a language translator that can translate spoken words into translated text;
storing all responses and entries in a user's medical database; and
storing all responses and entries in a medical research database base if opt in is selected by the user.

16. The method of claim 13, further comprising the steps of:
using the voice and text messages for tracking how the user/patient takes care of themselves;
tracking through an information exchange, how suggested treatments or actions are occurring for an individual user and comparing that to groups of users under the same orders to see if the orders can be better tailored or executed to obtain the desired results; and
learning systems can be indexed for learning related to different disease treatment methods around the world.

17. The method of claim 2, further comprising the steps of:
entering audio and video input for validation and identification;
attaching any recording to their human key identity;
sending any attached information to a recipient authenticated by the system;
storing information on a system server under the human key ID and user account;
transforming audio input into written text for publication;
creating text can from images, music, or video for publication;
publishing the information publicly or privately as a verified and authenticated item.

18. The method of claim 2, further comprising the steps of:
scanning an item for purchase;
adding the item to a database for later analysis;
completing a payment transaction for items using the human key;
re-scanning items as they are used;
adding used items them to a needed item database for replenishment;
generating alerts to a user when they are shopping at appropriate stores to remind them to purchase replenishments.

19. The method of claim 1, further comprising the steps of:
Logging in to verify an identity;
setting up a campaign with voice commands to raise money or to collaborate on a project;
verifying the campaign with an associated identify;
creating verified campaign video;
streaming campaign video;
attaching the campaign to any object, wall, steps or anything and can be linked to with virtual augmented reality devices such as a recorder projector or a thin client device equipped with projection means;
using a virtual augmented reality device to run a user campaign audio, video, or images at any location;
searching for locations of advertising displays;
selecting a specific location;
using a virtual augmented reality device to run a user campaign audio, video, or images at a specific location; and
sending notification that the campaign is at the specified location.

20. The method of claim 19, further comprising the steps of:
projecting an infrared point and calculating the vertical horizontal and depth of that point, utilizing GPS, or spatial point targeting if there is no GPS, by a device;
sending a signal to another user who walks by the location, if the advertising message is attached to that spatial point;
playing the ad, text, message, video, or any media in the mobile device.

21. The method of claim 20, further comprising the step of identifying and authorizing the recipient and device before sending a signal to another user who walks by the location, if the advertising message is attached to that spatial point.

22. The method of claim 20, further comprising the steps of:
taking a device to a specific point;
pointing the device at a spatial point;
recording or naming the location;
deciding if this will be a public or private location;
locating the spatial points on a map; and
attaching an audio or visual file to that spatial point for viewing in a public, private, secured, or unsecured manner.

23. The method of claim 22, further comprising the steps of:
establishing a target point;
attaching an advertisement to the target point; and
broadcasting an advertisement to a moving vehicle using a display device located in the vehicle when the vehicle moves close to the target point.

24. A method for identification and authentication of a user and protecting information executed by a machine, comprising the steps of:
recording audio and visual input of a user including recording visual background information by using a 3D camera to record audio and video;
providing automatic object identification when motion is detected;
comparing the background with the foreground;
forming a box 200 pixels from the center point of the moving objects discovered in field of view;
lining up a user's nose up with the center of the cross hairs in the analysis area;
selecting to register or sign in;
locking on to a center point and where ever object moves staying locked on to that center reference point;
locking on the image with 16 pixels edge around the profile of the person for processing and background is removed processing only occurs in center pixels;
typing a phrase or saying a phrase that is already registered;
verifying and identifying the submitted phrase;
searching the database for matches; and
returning information about the object.

25. The method of claim 24, further comprising the steps of:
collecting image color band pixels occurs after the first phrase is spoken;
determining color bands and the analysis areas;
determining a first generation and storing of pixel color band (PCB) wave form occurs in a first encryption;
repeating the encryption process for two or more encryption cycles;
storing numbers with lightness and darkness values filtered at 13 levels;
analyzing pixels patterns data for searching;
capturing the image from the video input analysis area;
converting the image to grayscale and to black and while with only edge line;
generating pixels and storing them;
determining evaluation distance variables around eyes and nose;
measuring and comparing points in the registration images compared to the sign in extracted images for positive identification and target points for other tests and pixel comparisons;
comparing data stored from registration to sign in during an evaluation step;
comparing data to determine if it is from the same human or object;
generating and providing results;
measuring and comparing in the registration images compared to the sign in images for positive identification and target points for other tests and pixel comparison;
providing access and displaying an access screen for a point match combined with 9 out of 17 positive point evaluation.

26. The method of claim 1, further comprising the steps of:
using the human key for identification and authentication of a user when a check is inserted into an ATM machine;
uploading and attaching the human key used for identification and authentication so now the check is secure, stored, and protected and verified that on that day was digitally signed in the human key system; and
cashing the check.

27. The method of claim 26, further comprising the steps of:
registering an issued check with the human key by the issuer;
presenting the check to a bank;
submitting a human key of a check recipient for identification and authentication;
accessing a human key server to confirm identification and authentication of the recipient;
notifying the bank of authentication of the check recipient;
submitting a human key of a check for identification and authentication;
accessing a human key server to confirm identification and authentication of the check;
notifying the bank of authentication of the check;
cashing the check buy the bank; and
sending confirmation of the cashed check to the human key server.

28. The method of claim 26, further comprising the steps of:
buying a debit card;
logging in to the human key server initiating a campaign account;
setting up an account to raise money that is tied to the purchased debit card;
loading money into the account;
activating the debit card;
using the card anywhere it is accepted; and
transferring fund contributions made to the campaign in the system to the debit card for use by the user.

29. The method of claim 28, further comprising the steps of:
entering a debit card number in the human key system;
registering the debit card, by video and audio print by looking into a camera and saying a login phrase;
transferring money, after registration, from a bank to the card;
loading the debit card from a credit card;
loading the debit card from an ATM;
moving money from a campaign in the system to the card; or
transferring money to another card in another country.
